(19) United States
(12) Patent Application Publication
(10) Pub. No.: US 2025/0203528 A1
(43) Pub. Date: Jun. 19, 2025

(54) UPLINK POWER CONTROL BASED ON UPLINK PATHLOSS

(71) Applicant: Sony Group Corporation, Tokyo (JP)

(72) Inventors: Hideji WAKABAYASHI, Basingstoke (GB); Yassin Aden AWAD, Basingstoke (GB); Vivek SHARMA, Basingstoke (GB); Yuxin WEI, Basingstoke (GB)

(73) Assignee: Sony Group Corporation, Tokyo (JP)

(21) Appl. No.: 18/847,277

(22) PCT Filed: Mar. 7, 2023
(86) PCT No.: PCT/EP2023/055807

§ 371 Date: Sep. 16, 2024

(30) Foreign Application Priority Data
Mar. 23, 2022 (EP) 22163909.9

(51) Int. Cl. H04W 52/24; H04W 52/14; H04W 52/32

(52) U.S. Cl. CPC H04W 52/242; H04W 52/146; H04W 52/325

(57) ABSTRACT

Apparatus and methods for determining an uplink pathloss for a communications device. A system comprises: a first infrastructure equipment; a second infrastructure equipment; and a communications device configured to communicate with the first infrastructure equipment via a first air interface provided by the first infrastructure equipment, and to communicate with the second infrastructure equipment via a second air interface provided by the second infrastructure equipment. The first air interface is an uplink-only interface for the communications device, and wherein the second air interface is both an uplink and downlink interface for the communications device. The uplink pathloss for the communications device on the first air interface is determined based on a received signal power of a first reference signal at the first infrastructure equipment and a transmission power of the first reference signal.

The present application claims the Paris Convention priority of European patent application EP22163909.9, filed 23 Mar. 2022, the contents of which are hereby incorporated by reference.

### BACKGROUND

### Field of Disclosure

The present disclosure relates to systems and methods for determining an uplink pathloss for a communications device.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current future wireless communications networks, for example those which may be referred to as 5G or new radio (NR) systems/new radio access technology (RAT) systems or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. URLLC type services therefore represent a challenging example for both LTE type communications systems and 5G/NR communications systems, as well as future generation communications systems.

The increasing use of different types of network infrastructure equipment, such as base stations and relay nodes/repeater devices, and terminal devices associated with different traffic profiles, as well as the consideration of deployment strategies for such network infrastructure equipment in various and varying environments, together give rise to new challenges for efficiently handling communications in wireless communications systems that need to be addressed.

### SUMMARY OF THE DISCLOSURE

The present disclosure can help address or mitigate at least some of the issues discussed above.

According to a first aspect, there is provided a system for determining an uplink pathloss for a communications device. The system comprises: a first infrastructure equipment; a second infrastructure equipment; and a communications device configured to communicate with the first infrastructure equipment via a first air interface provided by the first infrastructure equipment, and to communicate with the second infrastructure equipment via a second air interface provided by the second infrastructure equipment, wherein the first air interface is an uplink-only interface for the communications device, and wherein the second air interface includes a downlink interface for the communications device; wherein the first infrastructure equipment is configured to: receive, from the communications device via the first air interface, one or more reference signals; measure a received signal power of the one or more reference signals; and transmit the received signal power to the second infrastructure equipment; wherein the second infrastructure equipment is configured to: transmit, to the communications device via the second air interface, a first transmission indicative of the received signal power of the one or more reference signals; and wherein the communications device is configured to: identify, based on the first transmission, an uplink pathloss for the communications device on the first air interface; and control an uplink power for the communications device, based on the uplink pathloss.

According to a second aspect there is provided a system for determining an uplink pathloss for a communications device, the system comprising: a communications device, a first infrastructure equipment, and a second infrastructure equipment, wherein the communications device configured to communicate with the first infrastructure equipment via a first air interface provided by the first infrastructure equipment, and to communicate with the second infrastructure equipment via a second air interface provided by the second infrastructure equipment, wherein the first air interface is an uplink-only interface for the communications device, and wherein the second air interface includes a downlink interface for the communications device; wherein the communications device is configured to: determine a location of the communications device; receive, from the second infrastructure equipment, a location of the first infrastructure equipment, receive, from the second infrastructure equipment, propagation parameters affecting uplink transmissions from the communications device to the first infrastructure equipment; based on the location of the communications device, the location of the first infrastructure equipment, and the propagation parameters, calculate an uplink pathloss for the communications device on the first air interface; and control an uplink power for the communications device, based on the uplink pathloss.

Embodiments of the present technique, which, in addition to methods of operating infrastructure equipment, relate to methods of operating communications devices, to infrastructure equipment, communications devices, circuitry for communications devices, and circuitry for infrastructure equipment, to wireless communications systems, to computer programs, and to computer-readable storage mediums, can allow generally for the more efficient transmission and reception of data in wireless communications systems, and particularly for the more efficient transmission and reception of data in wireless communications.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 schematically illustrates communications devices communicating with infrastructure equipment in accordance with the first type of Uplink CoMP;

FIG. 5 schematically illustrates communications devices communicating with infrastructure equipment in accordance with the second type of Uplink CoMP;

FIG. 6A schematically illustrates a communications device communicating with infrastructure equipment in accordance with supplementary uplink;

FIG. 6B schematically illustrates a communications device communicating with infrastructure equipment in accordance with supplementary uplink;

FIG. 7 schematically illustrates a wireless communications network in which communications devices communicate with infrastructure equipment in accordance with supplementary uplink;

FIG. 8 schematically illustrates a wireless communications network in which a communications device performs uplink-only communication with infrastructure equipment in accordance with example embodiments;

FIG. 9 illustrates a system for determining an uplink pathloss for a communications device in accordance with an example embodiment;

FIG. 10 illustrates a system for determining an uplink pathloss for a communications device in accordance with an example embodiment;

FIG. 11 illustrates a system for determining an uplink pathloss for a communications device in accordance with an example embodiment;

FIG. 12 illustrates a system for determining an uplink pathloss for a communications device in accordance with an example embodiment;

FIG. 13 illustrates a method for a communications device in accordance with an example embodiment;

FIG. 14 illustrates a method for an infrastructure equipment in accordance with an example embodiment;

FIG. 15 illustrates a method for an infrastructure equipment in accordance with an example embodiment;

FIG. 16 illustrates a method for a communications device in accordance with an example embodiment;

FIG. 17 illustrates a method for an infrastructure equipment in accordance with an example embodiment;

FIG. 18 illustrates a method for a communications device in accordance with an example embodiment;

FIG. 19 illustrates a method for an infrastructure equipment in accordance with an example embodiment.

### DETAILED DESCRIPTION OF THE EMBODIMENTS

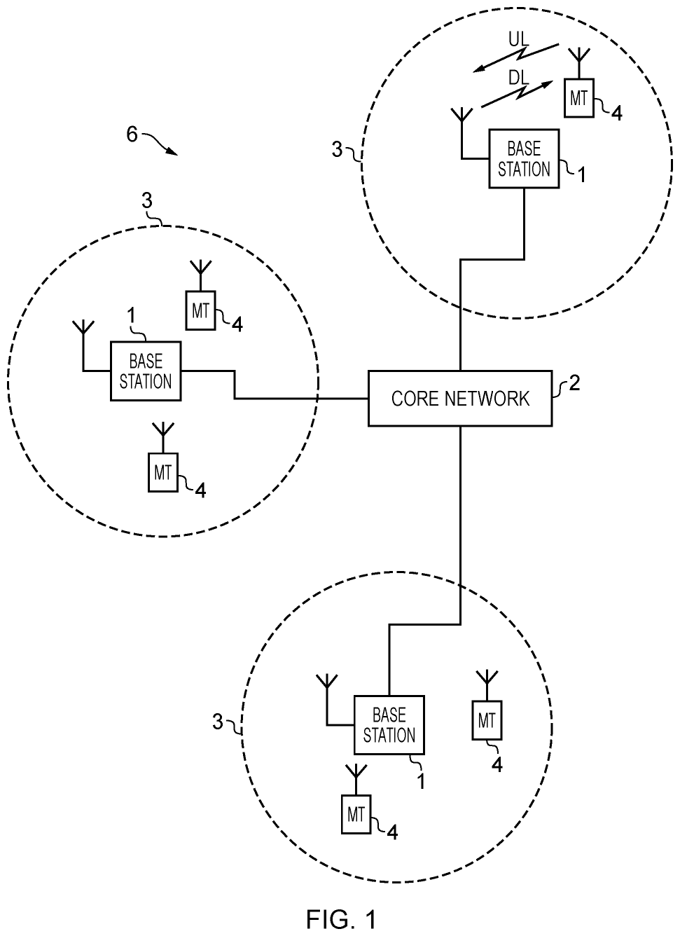

Long Term Evolution Advanced Radio Access Technology (4G) FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (alternatively referred to as a “cell”) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. The communications devices 4 may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

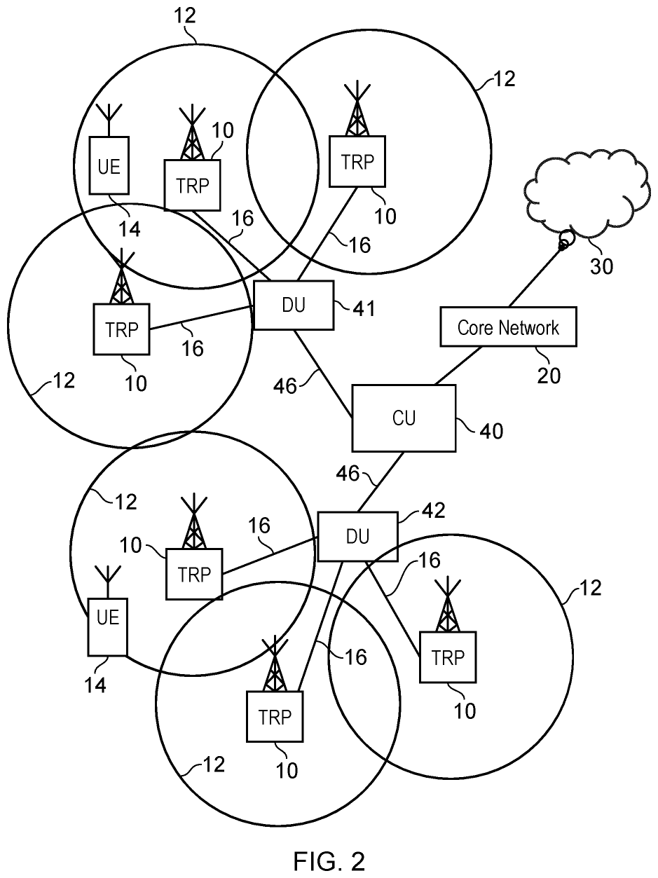

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices 14 and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the communications devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices 14 may lie with the controlling node/central unit and/or the distributed units/TRPs. As shown in FIG. 2, each TRP is surrounded by a coverage area 12 (or “cell”) within which a communications device 14 may exchange signalling with the central unit 40 via one of the distributed units/TRPs 10 associated with the coverage area 12. Each coverage area 12 may be generated or provided by the TRP 10 associated with that coverage area 12. Each TRP 10 may provide or generate its associated coverage area 12 under the control of the DU 42 and/or CU 40.

Alternatively stated, each coverage area 12 may be provided by infrastructure equipment of the wireless communications network.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

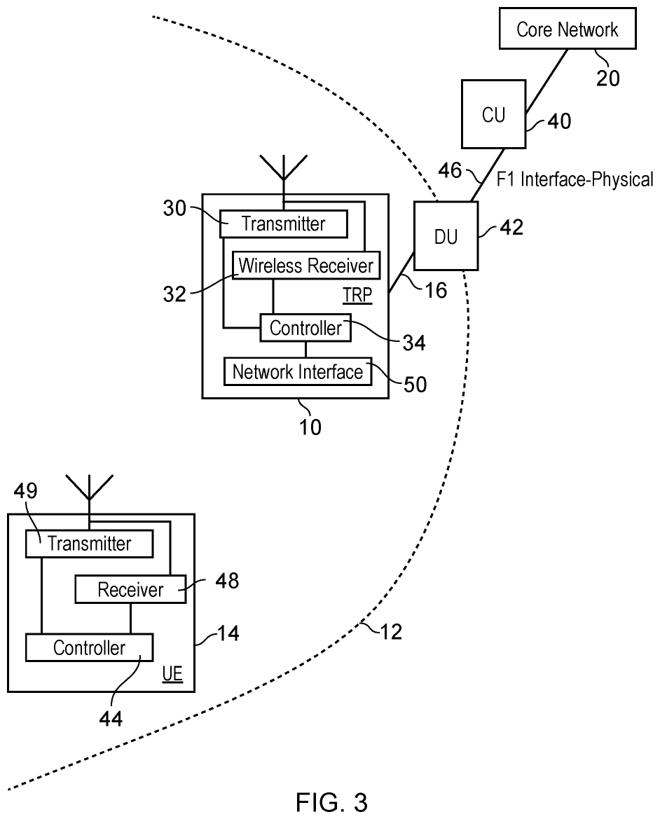

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more communications devices 14 within the coverage area 12 formed by the TRP 10. As shown in FIG. 3, an example communications device 14 (such as a UE) is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

Current 3GPP specifications allows complete flexibility of physical deployment of the network components. For example, a TRP and DU could be deployed in the same location or in different locations. Similarly, a CU and DU could be deployed in the same location or different locations, and a TRP, DU, and CU could be deployed in the same location or separately in two or three different locations.

### Asymmetric Uplink and Downlink Coverage

As mentioned above, infrastructure equipment of a wireless communications network can provide a coverage area within which communications devices can exchange signalling with the infrastructure equipment. In the case of an LTE network 6, such as that shown in FIG. 1, each coverage area 3 is provided by the base station 1 and is provided for the communications devices 4 to exchange signalling with each respective base station 1. In the case of an NR wireless communications network, such as that shown in FIG. 2, each coverage area is provided 12 by the TRP 10 under the control of the DU 42 and/or the CU 40 and is provided for the communications devices 14 to exchange signalling with the TRP 10, DU 42 and/or CU 40.

In more detail, the coverage areas 3, 12 shown in FIGS. 1 and 2 represent “symmetric coverage areas”. As will be appreciated by one skilled in the art, a symmetric coverage area is an area within which a communications device can perform uplink transmissions or receive downlink transmissions from infrastructure equipment of a wireless communications network.

However, in real deployments, an area within which a communications device can perform uplink transmissions with infrastructure equipment may be different to an area within which the communications device can receive downlink transmissions from the infrastructure equipment.

In other words, infrastructure equipment can provide a coverage area for downlink transmissions with one or more communications devices (hereinafter referred to as a “downlink coverage area”) and a coverage area for uplink transmissions with the one or more communications devices (hereinafter referred to as a “uplink coverage area”), where the downlink coverage area and the uplink coverage area do not cover the exact same geographical area. For example, the downlink area may be larger than, and encompass, the uplink coverage area. The extent of the downlink coverage area may be determined at least partly by a transmission power of the infrastructure equipment providing the coverage area. In one example, the higher the transmission power of the infrastructure equipment, the larger the downlink coverage area within which downlink communications can be received by a communications device. On the other hand, the extent of the uplink coverage area may be determined at least partly by a transmission power of the communications device performing the uplink transmission. In one example, the higher the transmission power of the communications device, the larger the uplink coverage area within which the uplink transmission can be received by an infrastructure equipment. As will be appreciated, transmitter and receiver capabilities between communications devices and infrastructure equipment vary. Typically, the downlink coverage area is larger than the uplink coverage area due to the higher transmission powers of infrastructure equipment compared with communications devices. This leads to scenarios in a wireless communications network where a communications device is located such that it can receive downlink transmissions but not uplink transmissions (i.e., the communications device is located within the downlink coverage area but not within the uplink coverage area). Uplink and downlink coverage areas which do not cover exactly the same geographical area are referred to as “asymmetric coverage areas”.

The term “coverage area” will be used from this point forth when it is not necessary to distinguish between uplink and downlink coverage areas. Therefore, references to “coverage area” should be construed as meaning either the uplink coverage area, the downlink coverage area or both. Furthermore, the terms “uplink coverage area” and “downlink coverage area” will be used when it is necessary to distinguish between uplink and downlink coverage areas.

In Release-18 of the 3GPP Standards, a current work item (WI) is the improvement of uplink coverage [2]. It is understood in this WI that coverage is one of the key factors that a network operator considers when commercialising cellular communication networks due to its direct impact on service quality as well as capital expenditures and operating expenses. Furthermore, uplink performance in particular could be the bottleneck in many real deployment scenarios. For example, there are many emerging vertical use cases that have heavy uplink traffic such as video uploading. However, as will be explained below, the improvement of uplink coverage is subject to a number of technical challenges, particularly in the case of asymmetric coverage.

The consequences of asymmetric coverage include at least the following:
Downlink pathloss and uplink pathloss may be different. This may require different power control methods for uplink and downlink transmissions.
Uplink and downlink propagation delays may be different. This may impact on timing advanced (TA) mechanism.
Channel reciprocity between uplink and downlink channels is not expected.

It has been suggested ([2]) that some of the technical challenges associated with asymmetric coverage are alleviated in dense deployment scenarios (where there are many communications devices close to one or more infrastructure equipment). For example, dense deployment scenarios are typically associated with lower pathloss due to the relatively short distances between communications devices and infrastructure equipment. In one example, the lower pathloss means that a wider bandwidth can be used for uplink transmissions using carrier aggregation while maintaining a relatively high power spectral density. However, dense deployments are associated with their own technical challenges. For example, a large cell planning effort may be required for inter-cell interference coordination, particularly to avoid communications collisions.

One solution which has been implemented to avoid collisions for uplink transmissions in a dense deployment is Uplink Co-ordinated Multipoint Transmission and Reception (CoMP) as will be now be explained.

### Uplink Co-Ordinated Multipoint Transmission and Reception (CoMP) in LTE

As mentioned above, dense deployment scenarios typically require inter-cell interference co-ordination to avoid communication collisions. One example of a known method for co-ordinating uplink transmissions to avoid uplink collisions is Uplink CoMP. There are currently two types of Uplink CoMP in LTE:
(i) Co-ordination between coverage areas (hereinafter referred to as the “First Type of Uplink CoMP”)
(ii) Multiple Receptions at neighbouring coverage areas (hereinafter referred to as the “Second Type of Uplink CoMP”).

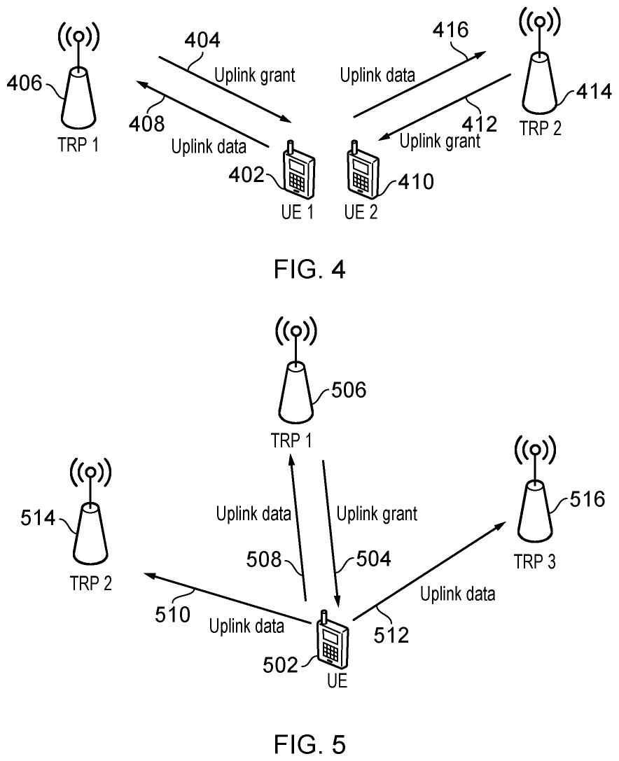

FIG. 4 schematically illustrates communications devices communicating with infrastructure equipment in accordance with the first type of Uplink CoMP. In particular, FIG. 4 illustrates a first UE 402 receiving an uplink grant 404 from a first TRP 406 and transmitting uplink data 408 to the first TRP 406 in accordance with the uplink grant 404. FIG. 4 also illustrates a second UE 410 receiving an uplink grant 412 from a second TRP 414 and transmitting uplink data 416 to the second TRP 414 in accordance with the uplink grant 412. Although not shown in FIG. 4, the first TRP 406 provides a coverage area for the first UE 402 and the second TRP 414 provides a coverage area for the second UE 410. If the first UE 402 is close to an edge of the coverage area provided by the first TRP 406, then the transmission of the uplink data 408 to the first TRP 406 may also reach the second TRP 414. For example, the first UE 402 may be located in an area of overlap of the coverage area provided by the first TRP 406 and the coverage area provided by the second TRP 414. Therefore, if the first UE 402 transmits the uplink data 408 to the first TRP 406 at the same time as the second UE 410 transmits the uplink data 416 to the second TRP 414, then the uplink data transmissions 408, 416 may collide.

In accordance with the first type of uplink CoMP, when the first TRP 406 sends the uplink grant 404 to the first UE 402, the second TRP 414 refrains from sending the uplink grant 412 to the second UE 410. Similarly, when the second TRP 414 sends the uplink grant 412 to the second UE 410, the first TRP 406 refrains from sending the uplink grant 404 to the first UE 402. This is an example of time scheduling (for example, uplink transmissions in different subframes). The first type of uplink CoMP also includes orthogonal methods such as frequency scheduling (uplink transmissions on different resource blocks) and space multiplexing (uplink receiver beamforming).

FIG. 5 schematically illustrates a communications device communicating with infrastructure equipment in accordance with the second type of Uplink CoMP. FIG. 5 illustrates a UE 502 receiving an uplink grant 504 from a first TRP 506 and transmitting uplink data 508 to the first TRP 506, where the same uplink data 510 and 512 is received at a second TRP 514 and a third TRP 516 respectively in accordance with the same uplink grant 504. A DU and/or CU connected to the first TRP 506 (not shown for clarity) can combine the uplink data 508, 510, 512 (e.g., maximum likelihood combining at decoder) from the three TRPs 506, 514, 516 (under the assumption that all three TRPs 506, 514, 516 are connected to the same DU/CU with optical fibre, i.e., ideal backhaul). Although not shown in FIG. 5, the first TRP 506, the second TRP 514 and the third TRP 516 are connected to the same DU which is connected to a CU. A limitation of this method is that it is impossible for the DU and/or CU to set different timing advances for communications devices served by the first TRP 506, the second TRP 514 and the third TRP 516. Furthermore, the fronthaul delay between each TRP 506, 514, 516 and DU and/or CU should be very short (i.e., ideal backhaul), otherwise it is impossible to combine the signals. On the other hand, no special UE capability is required for supporting uplink CoMP. This is because the functions of uplink CoMP are transparent from the UE perspective.

As explained above, uplink CoMP can provide mechanisms for reduced uplink interference in dense deployment scenarios. However, existing Uplink CoMP techniques are not easily applied to current NR networks. This is because NR networks make use of beamforming for directional transmissions between communications devices and infrastructure equipment.

3GPP have suggested ([2]) that one solution to improve reduce uplink interference in dense deployment scenarios is to deploy “uplink-only access points”. Currently, uplink-only access points can be provided by using one or more of Carrier Aggregation (CA), Dual Connectivity (DC) and Supplementary Uplink (SUL) as will be explained below.

### Carrier Aggregation (CA) and Dual Connectivity (DC)

Known techniques for providing uplink-only access points include Carrier Aggregation (CA) and Dual Connectivity (DC).

In carrier aggregation, communications between communications devices and infrastructure equipment can be performed over more than one component carrier. As will be appreciated by one skilled in the art, communications may be performed using a Primary Carrier (referred to as “PCell”) and a Secondary Carrier (referred to as “SCell”). Typically, the primary carrier communicates user plane data and control plane signalling and is therefore always active. In contrast, the secondary carrier only communicates user plane data. Therefore, secondary carriers may be selectively activated or deactivated depending on user plane data traffic.

Carrier aggregation is configured by a Media Access Control (MAC) layer. Therefore, as will be appreciated by one skilled in the art, the primary and secondary carrier should be controlled by the same scheduler in MAC layer. It is possible to deploy a primary carrier in one location and a secondary carrier in another location if there is a good backhaul link. For example, a primary carrier may be deployed in one location for uplink and downlink transmissions whereas a secondary carrier may be deployed in another location for uplink-only transmissions. In this way, carrier aggregation can be used to provide uplink-only access points.

Dual connectivity is similar to carrier aggregation. However, in dual connectivity, a communications device such a UE can simultaneously connect to two different infrastructure equipment such as two different base stations. One such base station may be referred to as the master cell group (MCG), whereas the other base station is referred to as the secondary cell group (SCG). The MCG and the SCG may provide different coverage areas. For example, the UE may communicate with the MCG using one carrier frequency and may simultaneously communicate with the SCG using another carrier frequency. For example, the MCG may provide a coverage area for both downlink and uplink transmissions whereas the SCG may provide an uplink coverage area for uplink transmissions only. In this way, dual connectivity can be used to provide uplink-only access points.

As will be appreciated by one skilled in the art, dual connectivity is handled by a common Packet Data Convergence Protocol (PDCP) layer entity for the communications links between the UE and the MCG, and between the UE and the SCG. The communications link between the UE and the MCG has a Radio Link Control (RLC), MAC and PHY entity. The communications link between the UE and the SCG has its own separate RLC, MAC and PHY entities. Therefore, traffic can be aggregated at the common PDCP layer. For example, downlink traffic can be aggregated at the common PDCP layer at the UE.

Dual Connectivity allows for the independent operation of the communications links and, consequently, increased flexibility. Therefore, dual connectivity can be used for not only base stations in the same wireless communications network but also for base stations in other wireless communications networks. For example, the MCG or SCG may form part of an LTE network and the other of the MCG or SCG may form part of an NR network.

A drawback of both carrier aggregation and dual connectivity is an increase in hardware complexity for the communications device. For example, in carrier aggregation and dual connectivity, a communications device requires more than transmitter and receiver. Furthermore, there are many possible combinations of carriers depending on a mobile network operator. It is therefore likely to be complex for a communications device to support all combinations of carriers.

One solution for implementing uplink-only access point while reducing communications device hardware complexity is supplementary uplink as will be explained in more detail below.

### NR Supplementary Uplink (SUL)

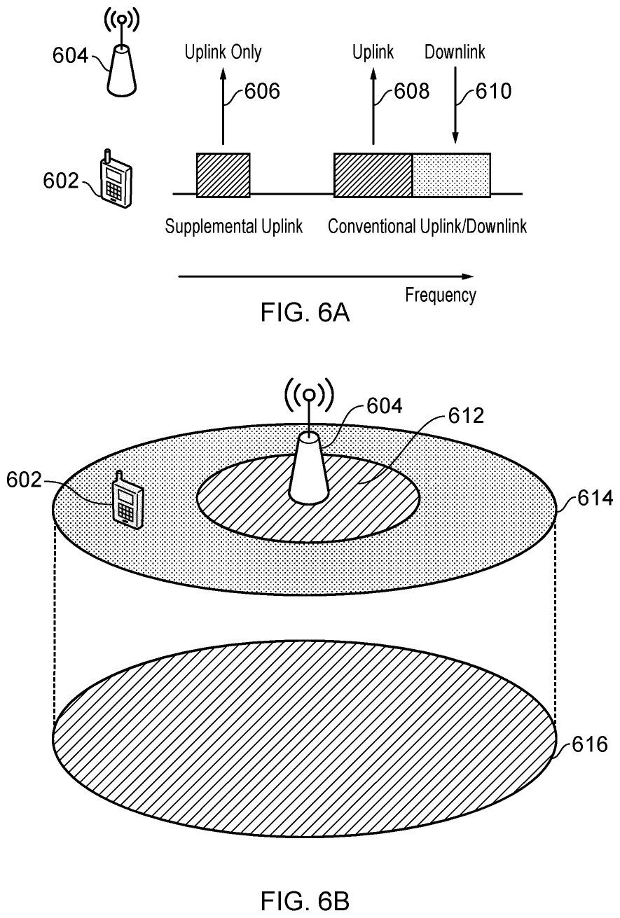

New Radio (NR) introduced the technique of “Supplementary Uplink”, which refers to the configuration of a communications device with two separate uplink carriers. An example of supplementary uplink compared with conventional uplink/downlink is shown in FIGS. 6A and 6B.

As shown in FIG. 6A, a communications device 602 is configured to transmit a conventional uplink transmission 608 to a TRP 604 and to receive a conventional downlink transmission 610 from the TRP 604. Although not shown in FIG. 6A, the TRP 604 forms part of infrastructure equipment which may also include a DU and/or CU. The conventional uplink transmission 608 and the conventional downlink transmission 610 may be transmitted according to Frequency Division Duplexing (FFD) techniques or Time Division Duplexing (TDD) techniques. In addition, in accordance with the principles of supplementary uplink, the communications device 602 is also configured to transmit a supplementary uplink transmission 606 to the TRP 604. Although the communications device 602 is configured to perform a conventional uplink transmission 608 and a supplementary uplink transmission 606, it cannot perform both uplink transmissions 606, 608 at the same time.

The supplementary uplink transmission 606 is on a carrier which is reserved for uplink transmissions only. A frequency and bandwidth of the carrier used for the uplink transmission 606 is controlled by a network operator and therefore depends on the frequency planning of the network operator. A bandwidth of the carrier used for the supplementary uplink transmission 606 is typically narrower than a bandwidth of a carrier of the conventional uplink transmission 608. Additionally, a frequency of the carrier used for the supplementary uplink transmission 606 is typically lower than a frequency of a carrier of the conventional uplink transmission 608. As will be appreciated, the use of a lower frequency carrier can improve uplink coverage by reducing pathloss. However, the use of a narrower bandwidth means that the carrier has a lower capacity for carrying data.

In the example shown in FIG. 6A, the carrier for the supplementary uplink transmission 606 and the carrier for the conventional uplink transmission 608 are co-located on the same site. In other words, although the frequency of the carrier for the supplementary uplink transmission 606 and the conventional uplink transmission 608 is different, the same TRP, DU and CU controls scheduling of the carrier for the supplementary uplink transmission 606 and the carrier for the conventional uplink transmission 608.

As shown in FIG. 6B, the TRP 604 provides a conventional downlink coverage area 614 in which the conventional downlink transmission 610 may be transmitted to the communications device 602, a conventional uplink coverage area 612 in which the conventional uplink transmission 608 may be received from the communications device 602 and a supplementary uplink coverage area 616 in which the supplementary uplink transmission 606 may be received from the communications device 602. As explained above, since the carrier for the supplementary uplink transmission 606 has a lower frequency than the carrier for the conventional uplink transmission 608, then the pathloss is lower and therefore the supplementary uplink coverage area 616 is larger than the conventional uplink coverage area 612.

From a communications device complexity perspective, supplementary uplink may be simpler than carrier aggregation or dual connectivity. In supplementary uplink, the communications device does not have to receive the downlink transmissions on the carrier reserved for supplementary uplink because this carrier is reserved for uplink transmissions only. Therefore, the communications device does not require additional receiver functions beyond those required to receive conventional downlink transmissions. In addition, the communication device is not required to have transmission power amplifier capability for simultaneous transmission for normal uplink carrier and supplemental uplink. Accordingly, communications device hardware complexity is reduced.

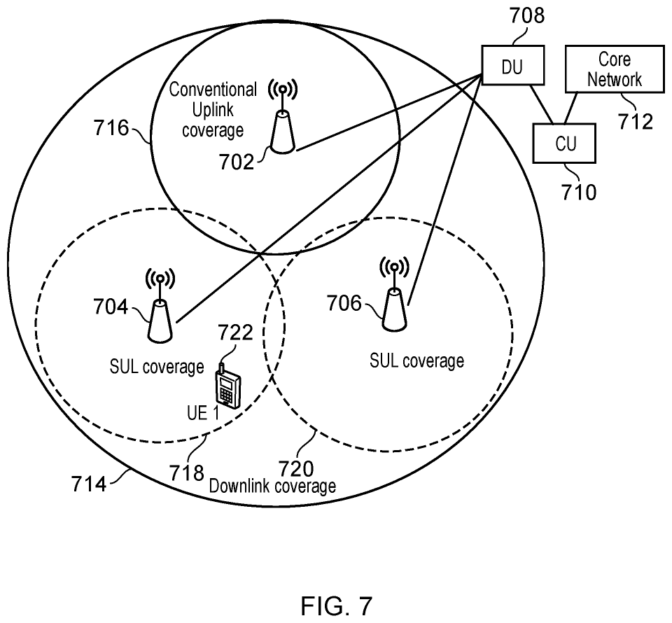

However, arrangements shown in FIGS. 6A and 6B may not be suitable for heavy uplink traffic use cases (such as video uploading). As mentioned previously, if a low frequency is used for the supplementary carrier then the corresponding bandwidth is narrower. Therefore, as will be explained with reference to FIG. 7, it is possible to use a higher frequency for the supplementary carrier which increases bandwidth. However, a higher frequency also means increased pathloss and therefore a reduced coverage area for supplementary uplink. Therefore, a plurality of TRPs are deployed as uplink-only access points to extend the coverage area provided for uplink-only transmissions. Such an arrangement is shown in FIG. 7.

FIG. 7 schematically illustrates wireless communications network comprising a plurality of TRPs 702, 704, 706 each connected to a distributed unit 708. The distributed unit 708 is connected to a central unit 710 and the central unit 710 is connected to a core network 712. The plurality of TRPs 702, 704, 706 comprise a conventional TRP 702 for providing conventional uplink and downlink coverage, a first supplementary TRP 704 for providing supplementary uplink coverage and a second supplementary TRP 706 for providing supplementary uplink coverage. The conventional TRP 702 provides a downlink coverage area 714 and an uplink coverage area 716. The first supplementary uplink TRP 704 provides a first supplementary uplink coverage area 718 and the second supplementary uplink TRP 706 provides a second supplementary uplink coverage area 720. In FIG. 7, the conventional uplink coverage area 716, the first supplementary uplink coverage area 718 and the second supplementary uplink coverage area are provided at different locations. Although the uplink coverage areas 716, 718 720 are shown as partially overlapping, it will be appreciated that, in other arrangements, the uplink coverage areas 716, 718 720 do not overlap.

As shown in FIG. 7, a communications device 722 is located within the first supplementary uplink coverage area 718 and is outside the conventional uplink coverage area 716. Therefore, the communications device 722 cannot perform uplink transmissions with the conventional uplink TRP 702 but can perform uplink transmissions with the first supplementary uplink TRP 704. For further details of supplementary uplink can be found in TS 38.101-1 [3], which is hereby incorporated by reference in its entirety.

As discussed above, the realisation of dense deployment for uplink in asymmetric coverage scenarios can be achieved by reducing inter-cell interference techniques, such as Uplink CoMP, and/or the deployment of uplink-only access points as part of carrier aggregation, dual connectivity and/or supplementary uplink.

The implementation of such uplink-only access points in dense deployment scenarios creates further technical challenges in NR networks. For example, the uplink and downlink pathloss may be different, and conventional methods for measuring the uplink pathloss rely upon a downlink transmission from the TRP in question to the communications device, however this is not possible with uplink-only access points.

Accordingly, technical challenges exist in efficiently providing improved uplink coverage.

### Uplink Pathloss Measurement

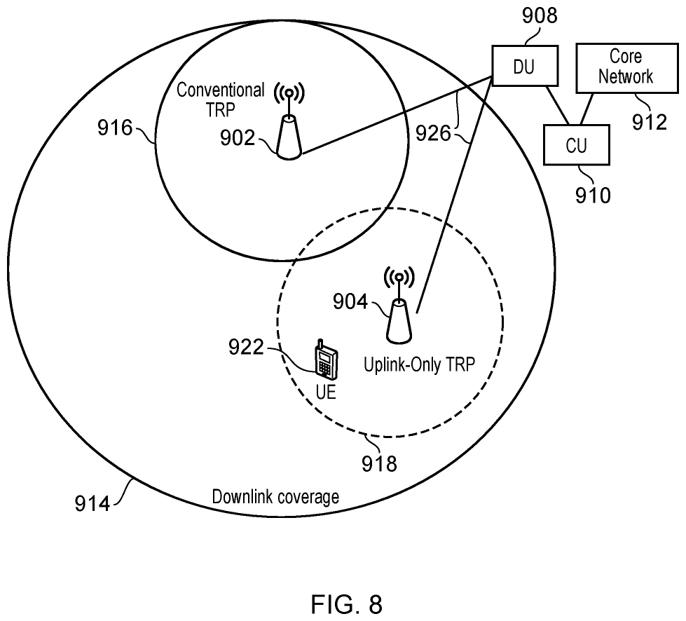

Example embodiments will be explained below with reference to the example wireless communications network illustrated in FIG. 8. FIG. 8 schematically illustrates communications between a communications device and infrastructure equipment in an asymmetric coverage scenario. In particular, FIG. 8 schematically illustrates wireless communications network comprising a plurality of TRPs 902, 904 each connected to a distributed unit 908 via respective fronthaul links 926. The distributed unit 908 is connected to a central unit 910 and the central unit 910 is connected to a core network 912. The plurality of TRPs 902, 904 comprise a conventional TRP 902 for providing conventional uplink and downlink coverage, and an uplink-only TRP 904 for providing uplink-only coverage. The conventional TRP 902 provides a downlink coverage area 914 and an uplink coverage area 916. The uplink-only TRP 904 provides an uplink-only coverage area 918. In FIG. 8, the conventional uplink coverage area 916, the uplink-only coverage area 918 are provided at different locations. Although the uplink coverage areas 916, 918 are shown as partially overlapping, it will be appreciated that, in other arrangements, the uplink coverage areas 916, 918 do not overlap.

As shown in FIG. 8, a communications device 922 is located within the uplink-only coverage area 918 and is outside the conventional uplink coverage area 916. Therefore, the communications device 922 cannot perform uplink transmissions with the conventional uplink TRP 902 but can perform uplink transmissions with the uplink-only TRP 904.

As will be appreciated, the CU 910 controls control plane signalling to and from the conventional TRP 902 and the uplink-only TRP 904. For example, the CU 910 is configured to control Radio Resource Control (RRC) signalling to and from the conventional TRP 902 and the uplink-only TRP 904. The DU 908 is configured to control baseband processing and scheduling for the conventional TRP 902 and the uplink-only TRP 904. As will be appreciated, the uplink-only TRP 904 is connected to the same DU 908 and CU 910 as the conventional TRP 902 because the uplink-only TRP 904 and the conventional TRP 902 share the same RRC protocol header and scheduler.

The conventional TRP 902 is configured to transmit and receive signals to and from the communications device 922. For example, the TRP 902 is configured to transmit downlink transmissions to, and receive uplink transmissions from, the communications device 922. The conventional TRP 902 is configured to receive signals from the communications device 922. For example, the TRP 902 is configured to receive uplink transmissions from the communications device 922 which may be passed onto the CU 910 or core network 912 via the DU 908. In one example, the conventional TRP 902 may broadly correspond to the conventional TRP 702 shown in FIG. 7 and the uplink-only TRP 904 may correspond broadly to one of the supplementary uplink TRPs 704, 706 shown in FIG. 7. In another example, in a dual connectivity scenario, the conventional TRP 902 may belong to an MCG and the uplink-only TRP 904 may belong to an SCG. In another example, in a carrier aggregation scenario, the conventional TRP 902 may transmit downlink transmissions and receive uplink transmissions on a primary carrier, and the uplink-only TRP 904 may receive uplink transmissions on a secondary carrier.

Although FIG. 8 illustrates physically separate TRPs, a DU and CU, the physical arrangement of these nodes can be altered by the network operator. For example, the functions performed by the conventional TRP 902, the DU 908 and the CU 910 may be performed by a single apparatus. Similarly, the functions performed by the uplink-only TRP 904, the DU 908 and the CU 910 may be performed by a single apparatus. In some arrangements, the functions performed by the conventional TRP 902, the uplink-only TRP 904, the DU 908 and the 910 may be performed by the same apparatus. Therefore, although the foregoing disclosure will separately refer to “TRPs”, “DUs”, and “CUs” for the purposes of clarity, this should not be construed as implying that these components are necessarily located on physically separate apparatus.

Furthermore, as will be appreciated by one skilled in the art, a combination of a particular TRP, DU and CU may be referred to as a “gNB”, which may, in some arrangements, perform some or all of the functions of a TRP, DU and CU. Therefore, references to “gNB” should be construed as referring to an apparatus configured to perform some or all of the functions of a TRP, DU and/or CU. The gNB may be alternatively referred to as a “base station”.

In the context of FIG. 8, and the following Figures, the term “infrastructure equipment” should be construed as referring to one or more of the conventional TRP 902, the uplink-only TRP, the DU 908 and the CU 910.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

In example wireless communications networks such as those of FIG. 8, conventional techniques for measuring an uplink pathloss for the communications device 922 cannot be used. In particular, in conventional networks the uplink pathloss may be determined by measuring a downlink signal (e.g. a common reference signal (CRS) or channel status information reference signal (CSI-RS) or synchronization signal block (SS-Block)) from a TRP to a communications device. However, in the example network of FIG. 8, the communications device 922 does not have downlink coverage from the uplink-only TRP 904. As such, no downlink signals from the TRP 904 to the UE 922 can be used to determine the uplink pathloss from the UE 922 to the TRP 904.

In addition, attempting to calculating an uplink pathloss based on an uplink signal, rather than a downlink signal, provides additional challenges. For example, there is generally no stable uplink signal from the communications device 922 to the TRP 904 which can be reliably measured to determine the uplink pathloss. In other words, there is no uplink signalling analogous to synchronization signal block (SS-Block) signalling or a channel status information reference signal (CSI-RS) that could be used to determine an uplink pathloss. Potential candidate signalling such as demodulation signals (DMRS) or sounding reference signalling (SRS) are transmitted by communications devices at varying power levels, and there is no mechanism for a communications device to inform infrastructure equipment of the transmission power (which is needed in order to calculate the uplink pathloss). However, the present inventors have identified approaches that allow the uplink pathloss from a communications device to an uplink-only TRP to be calculated.

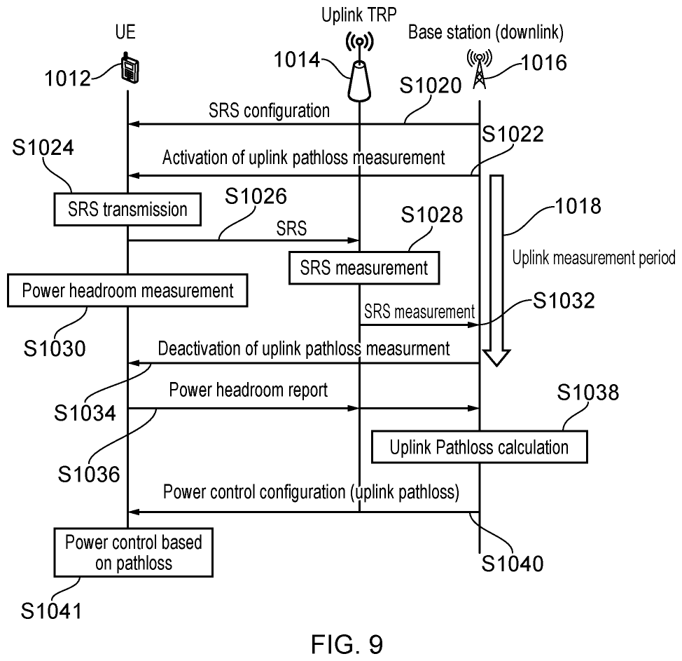

FIG. 9 shows an example system for calculating an uplink pathloss for a UE 1012. A first infrastructure equipment (e.g. an uplink TRP 1014) provides uplink-only coverage to the UE 1012, while a second infrastructure equipment (e.g. a base station 1016) provides downlink coverage to the UE 1012 (and may additionally provide uplink coverage to the UE 1012). While the first infrastructure equipment 1014 provides uplink-only coverage to the UE 1012, the first infrastructure equipment may be capable of providing downlink coverage to other UEs, such as a UE that is connected with a different carrier.

Moreover, while the first infrastructure equipment 1014 (uplink TRP) and the second infrastructure equipment 1016 (base station) are shown in FIG. 9 as distinct entities, it should be appreciated that the first infrastructure equipment 1014 and second infrastructure equipment 1016 may be co-located or located separately to varying degrees. For example, the uplink TRP 1014 and the base station 1016 may include distinct TRPs (e.g. similar to TRPs 904 and 902 in FIG. 8) that are connected to the same DU (such as DU 908 in FIG. 8). Similarly, the base station 1016 may be thought of as including a DU that is shared by the two distinct TRPs. In other examples, the uplink TRP 1014 and the base station may share a common TRP (e.g. similar to TRP 604 in FIG. 6B). In such an example, the first infrastructure equipment 1014 may be thought of as the common TRP, while the second infrastructure equipment 1016 may be a DU (and optionally a CU), which may transmit and receive messages to/from the UE 1012 via the common TRP.

In the foregoing discussion, the term “uplink TRP” is used to generally refer to the first infrastructure equipment 1014 of any of these preceding examples, while the term “base station” is used to generally refer to the second infrastructure equipment 1016 of any of these preceding examples.

The uplink TRP 1014 and the base station 1016 may also have a variety of relationships, depending on the specific application. For example, the uplink TRP 1014 and the base station 1016 may be included in different cells. In such an example, if CA is used, the uplink cell (i.e. the coverage area provided by the uplink TRP 1014) may be a Pcell, and the downlink cell (i.e. the coverage area provided by the base station 1016) may be an Scell (or vice versa), where both cells are controlled by the same CU. Conversely, when dual connectivity is used, the uplink cell may belong to a MCG, while the downlink cell may belong to an SCG, or vice versa.

In the example of FIG. 9, the base station 1016 transmits (S1020) configuration information for a sounding reference signal (SRS) to be transmitted by the UE 1012. The configuration information for the SRS may specify that the UE 1012 is to transmit SRS signalling with a constant transmission power over a predetermined uplink measurement period. The configuration information may in some cases specify the transmission power for the SRS transmissions, or in other cases the base station 1016 may separately broadcast a predetermined transmission power at which UEs (including UE 1012) are to transmit the modified SRS transmissions. The gNB may also transmit to the UE 1012 a message activating (S1022) an uplink pathloss measurement process for the UE 1012, which may initiate the transmission of SRS signalling and power headroom measurements, as well as begin an uplink measurement period 1018. The uplink measurement period 1018 may be defined as the time between the activation of SRS measurement (S1022) and deactivation of that the SRS measurement (S1034). Alternatively, the uplink measurement period 1018 may be defined by a timer value commencing from the SRS measurement activation (S1022), where the timer value may be provided with the SRS measurement activation (S1022) or via RRC signalling, or the timer value may be a pre-defined timer.

Within the uplink measurement period 1018, the UE 1012 generates (S1024) and transmits (S1026) SRS signalling to the uplink TRP 1014. The uplink TRP 1014 then measures (S1028) the received signal power of the SRS. Multiple SRS transmissions may be sent by the UE 1012 within the uplink measurement period 1018 and the uplink TRP 1014 may measure the received signal power of each of these SRS transmissions. In alternative arrangements, the UE 1012 may send only a single SRS transmission. The uplink TRP 1014 may then send (S1032) the measurement of the received signal power to the base station 1016. Where the received signal power of multiple SRS transmissions is measured, the uplink TRP 1014 may calculate an average received signal power and transmit the average received signal power to the base station 1016. Alternatively, the uplink TRP 1014 may transmit the individual received signal power measurements to the base station 1016, where the base station 1016 calculates the average received signal power.

The UE 1012 also determines (S1030) the transmission power of the SRS transmissions. For example, the UE 1012 may determine the transmission power of each of the SRS transmissions within the uplink measurement period 1018. This may be done, for example, during a power headroom measurement. In the example of FIG. 9 the transmission power of each SRS transmission is constant (i.e. constant within the margin of error of the UE 1012). The base station 1016 may transmit (S1034) a notification to the UE 1012 to deactivate the uplink pathloss measurement process, which ends the uplink measurement period 1018. The UE 1012 therefore stops SRS transmissions and power headroom measurements.

After the uplink pathloss measurement process has ended, the UE 1012 transmits (S1036) the transmission power of the SRS transmissions to the base station 1016 (e.g. via the uplink TRP 1014). The transmission power of the SRS transmissions may be included within a power headroom measurement report. Accordingly, the amount of additional signalling required may be reduced, as 3GPP already requires the sending of power headroom reports at particular times.

After received the SRS received signal power measurement(s) and the SRS transmission power, the base station 1016 uses these to calculate (S1038) the uplink pathloss between the UE 1012 and the uplink TRP 1014. The uplink pathloss is calculated as the transmission power of the SRS transmissions minus the received signal power of the SRS transmissions. The base station 1016 then transmits (S1040) the uplink pathloss to the UE 1012, which may use the uplink pathloss to control (S1042) its transmission power.

Accordingly, the system of FIG. 9 is capable of measuring an uplink pathloss between a UE 1012 and an infrastructure equipment with an uplink only interface for the UE 1012, where it is not possible to rely on conventional downlink transmissions. This is done using a modified SRS process where the UE 1012 transmission power is constant and is reported to a base station 1016 with a downlink interface for the UE 1012.

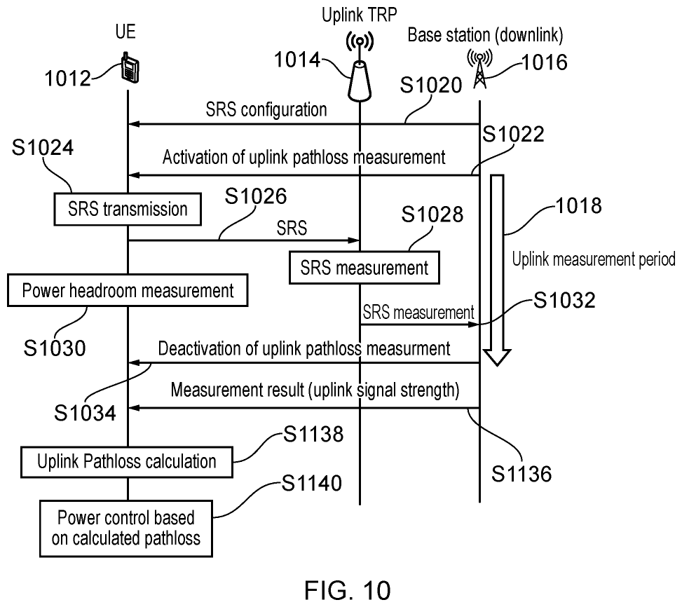

FIG. 10 shows an example system for calculating an uplink pathloss for a UE 1012. In the example of FIG. 9, the uplink pathloss is calculated by the base station 1016, while in the present example of FIG. 10, the pathloss is calculated by the UE 1012. The system of FIG. 10 is substantially similar to that of FIG. 9. In particular, the first infrastructure equipment (e.g. an uplink TRP 1014) provides uplink-only coverage to the UE 1012, while the second infrastructure equipment (e.g. a base station 1016) provides downlink coverage to the UE 1012 (and may additionally provide uplink coverage to the UE 1012). As with FIG. 9, while the first infrastructure equipment 1014 provides uplink-only coverage to the UE 1012, the first infrastructure equipment may be capable of providing downlink coverage to other UEs, such as a UE that is connected with a different carrier. Furthermore, the first infrastructure equipment 1014 and the second infrastructure equipment 106 of FIG. 10 may be co-located (or not) to varying degrees, and well as having a number of different inter-relationships, in the same manner as described above in relation to FIG. 9.

The initial process shown in FIG. 10 is substantially similar to that of FIG. 9. In particular, the process of transmitting (S1020) by the base station 1016 of a configuration information of the SRS signalling up to and including the transmission (S1034) by the base station 1016 of a notification to the UE 1012 to deactivate the uplink pathloss measurement process may be the same as that described above in relation to FIG. 9.

After the uplink measurement period 1018 has ended, the UE 1012 does not transmit the transmission power of the SRS transmissions to the base station 1016. Instead, the base station 1016 transmits (S1136) the measurement of the received signal power (at the uplink TRP 1014) of the SRS transmissions to the UE 1012. Using the transmission power of the SRS transmissions (as determined by the UE 1012) and the measurement of the received signal power received from the base station 1016, the UE 1012 calculates (S1138) the uplink pathloss between the UE 1012 and the uplink TRP 1014. The UE 1012 may then use the uplink pathloss to control (S1140) its transmission power.

Accordingly, the system of FIG. 9 is capable of measuring an uplink pathloss between a UE 1012 and an infrastructure equipment with an uplink only for the UE 1012, where it is not possible to rely on conventional downlink transmissions. This is done using a modified SRS process where the UE 1012 transmission power is constant and is reported to a base station 1016 with a downlink interface for the UE 1012.

The above approaches described in relation to FIGS. 9 and 10 require the UE 1012 to transmit the SRS transmissions at a constant transmission power within the uplink measurement period 1018. Accordingly, the gNB sends the SRS configuration (S1020) to the UE 1012 to configure the SRS for pathloss measurement, where the SRS pathloss measurement transmissions are different to other SRS transmissions for beam management, which may also be transmitted by the UE 1012 to the uplink TRP 1014 and/or base station 1016. In contrast, conventional SRS transmissions for beam management are usually transmitted at a variety of different transmission powers because of dynamic power control. However, it is possible to modify the approach of FIG. 9 to allow the SRS transmission power to be varied within the uplink measurement period 1018.

The SRS transmission itself can be further modified to include an indication of the transmission power. In NR and 5G, SRS is based on Zadoff-Chu (ZC) sequences. The length of the sequence can be equal to the number of subcarriers in one physical resource block (PRB). By creating a cyclic shift of the same base sequence, a total of 12 sequences (numbered 0-11) can be further generated from a single PRB of 12 subcarriers. Based on these 12 cyclic shifts, a one-to-one mapping between a UE uplink SRS power (SRS transmission power) and the cyclic shifts of the SRS sequences can be predefined. Table 1 below provides an example of such a mapping:

TABLE 1
Example of one-to-one mapping between a UE UL
SRS power and the cyclic shift of the SRS.

| | |
|---|---|
| UE UL | Corresponding cyclic shift |
| SRS power | of the SRS sequence |

| | | |
|---|---|---|
| 23 | dBm | 0 |
| 21 | dBm | 1 |
| 19 | dBm | 2 |
| 17 | dBm | 3 |
| 15 | dBm | 4 |
| 13 | dBm | 5 |
| 11 | dBm | 6 |
| 9 | dBm | 7 |
| 7 | dBm | 8 |
| 5 | dBm | 9 |
| 3 | dBm | 10 |
| 1 | dBm | 11 |

Using mappings such as those shown in Table 1, a UE 1012 must select a transmission power for the SRS (for example based on a location of the UE) from the predefined list of transmission powers and then generate the SRS sequence based on the corresponding cyclic shift index. When receiving the SRS transmission, the uplink TRP 1014 or base station 1016 determines which cyclic shift a UE has used for its SRS transmission by correlating different cyclic shifts of the base sequence of length 12, where the cyclic shift with the highest output peak is determined to be the cyclic shift used by the UE 1012 for its uplink SRS transmission. The uplink TRP 1014 or base station 1016 is therefore able to determine the SRS transmission power using the mappings between the cyclic shifts and the transmission power.

This approach allows the SRS transmissions to be transmitted with various different powers, meaning that conventional SRS transmissions do not need to be modified to be transmitted with constant power. Furthermore, this approach also reduces the amount signalling required to perform the uplink pathloss measurement as the base station is able to determine the uplink pathloss based on a single transmission from the UE 1012, such that steps S1030 and S1036 shown in FIG. 9 are not required). The base station 1016 uses the transmission power of the SRS transmissions, along with the received SRS signal power, to determine the uplink pathloss between the UE and the uplink TRP in the same manner as described above in relation to FIG. 9. The uplink pathloss is transmitted to the UE 1012 which may then use the uplink pathloss to control a transmission power of uplink transmissions.

The above-described approaches utilise knowledge of the transmission power of an SRS transmission and measurement of the received power of the SRS transmission to calculate the uplink pathloss. However, in many cases it is possible to estimate the uplink pathloss between a UE and an uplink TRP, without performing any measurements. For example, an estimate of the pathloss between the UE and the uplink TRP may be calculated based on the Okumura-Hata model.

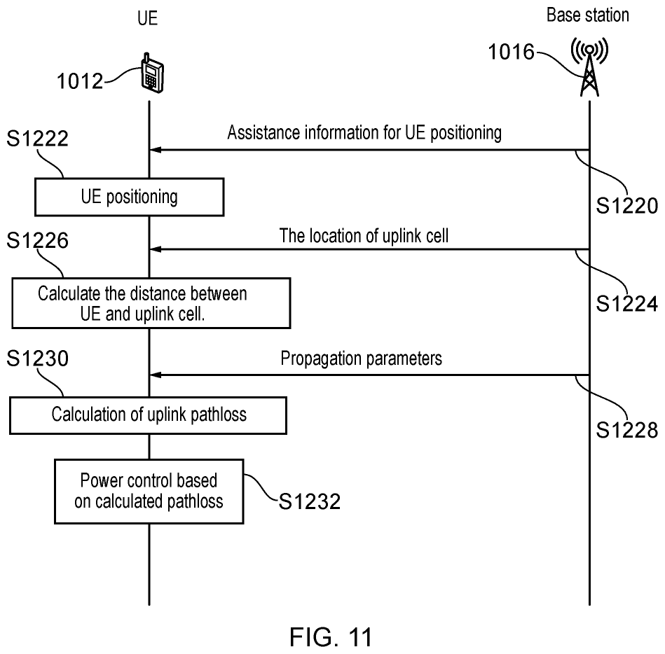

FIG. 11 illustrates an approach for estimating the pathloss between the UE 1012 and an uplink TRP 1014 (not shown in FIG. 11). As with FIGS. 9 and 10, a first infrastructure equipment (e.g. an uplink TRP 1014) provides uplink-only coverage to the UE 1012, while second infrastructure equipment (e.g. a base station 1016) provides downlink coverage to the UE 1012 (and may additionally provide uplink coverage to the UE 1012). As with FIGS. 9 and 10, while the first infrastructure equipment 1014 provides uplink-only coverage to the UE 1012, the first infrastructure equipment may be capable of providing downlink coverage to other UEs, such as a UE that is connected with a different carrier. Furthermore, the first infrastructure equipment 1014 and the second infrastructure equipment 106 may be co-located (or not) to varying degrees, and well as having a number of different inter-relationships, in the same manner as described above in relation to FIG. 9.

In the example of FIG. 11, a base station 1016 may transmit (S1220) assistance information to the UE 1012. This assistance information may include information that may be used by the UE 1012 to determine its own location (i.e. GNSS information). The UE 1012 then determines (S1222) its own location.

The base station 1016 also transmits (S1224) a location of the uplink TRP 1014 to the UE 1012. Based on the location of the UE 1012 and the location of the uplink TRP 1014, the UE 1012 then determines (S1226) the distance between the UE 1012 and the uplink TRP 1014. The base station 1016 transmits (S1228) further propagation parameters to the UE 1012 that affect transmission of uplink signals from the UE 1012 to the uplink TRP 1014 (e.g. antenna height, environment type (e.g. urban, sub-urban, or rural), presence of obstacle(s), uplink frequency). Based on the distance between the UE 1012 and the uplink TRP 1014 and the propagation parameters, the UE 1012 then estimates (S1230) the uplink pathloss between the UE 1012 and the uplink TRP 1014. The UE 1012 may then control (S1232) a transmission power for uplink communications to the uplink TRP 1014 based on the pathloss.

In this manner, it is possible to obtain an estimate of the uplink pathloss without performing measurements of a received signal power. This is particularly beneficial in scenarios where such measurement may be difficult or not possible.

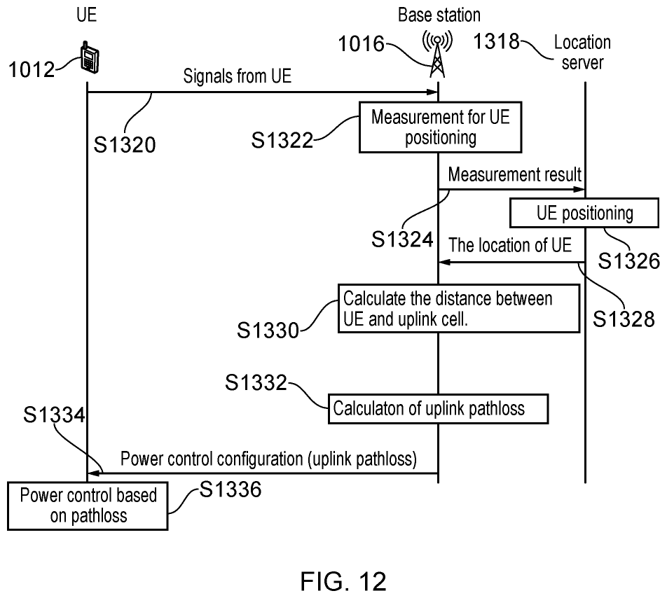

In the example of FIG. 11, the UE 1012 estimates the uplink pathloss, however it is equally possible for the uplink pathloss to be estimated by the base station 1016 and transmitted to the UE 1012, as shown in FIG. 12. In particular, a base station 1016 may receive (S1320) a reference signal transmitted from a UE 1012 which the base station 1016 may measure (S1322) in order to determine positional information of the UE 1012. For example, the base station may measure an Uplink Time Difference Of Arrival (U-TDOA). Alternatively, the uplink TRP 1014 (not shown in FIG. 12) may receive the reference signal from the UE 1012, and the uplink TRP 1014 may measure the signal (e.g. measure the U-TDOA), before transmitting the result of the measurement to the base station.

In both cases, the base station 1016 may transmit (S1324) the result of the measurement to a location server 1318. The location server 1318 uses the result of the measurement to determine (S1326) a location of the UE 1012 and transmit (S1328) the UE 1012 location to the base station 1016. The base station 1016 is therefore able to determine (S1330) a distance between the UE 1012 and the uplink TRP 1014, as well as propagation parameters affecting transmission of uplink signals from the UE 1012 to the uplink TRP 1014, which the base station uses to estimate (S1332) the uplink pathloss (e.g. based on the Okumura-Hata model). The base station 1016 then transmits (S1334) the uplink pathloss to the UE 1012 which is able to control (S1336) a transmission power for uplink communications to the uplink TRP 1014 based on the uplink pathloss.

Accordingly, it is possible for both the UE 1012 and the base station 1016 to estimate the uplink pathloss between the UE 1012 and the uplink TRP 1014, without requiring measurement of uplink transmissions.

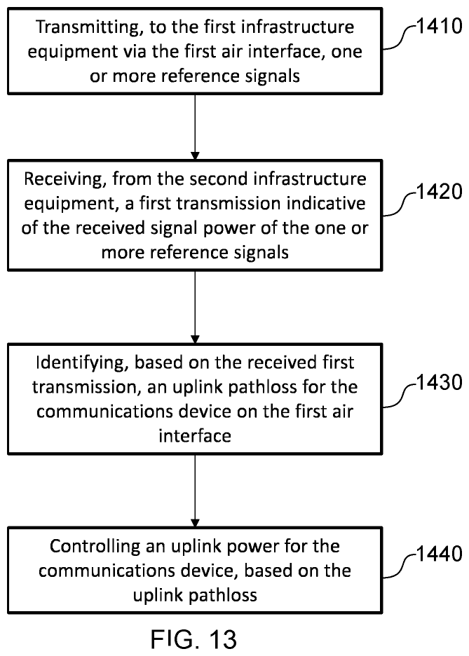

FIG. 13 illustrates a method for a communications device in accordance with an example embodiment. The communications device is communications device configured to communicate with a first infrastructure equipment via a first air interface provided by the first infrastructure equipment, and to communicate with a second infrastructure equipment via a second air interface provided by the second infrastructure equipment, wherein the first air interface is an uplink-only interface for the communications device, and wherein the second air interface includes a downlink interface for the communications device.

The method of FIG. 13 includes a step 1410 of transmitting, to the first infrastructure equipment via the first air interface, one or more reference signals. The method proceeds to step 1420 of receiving, from the second infrastructure equipment, a first transmission indicative of the received signal power of the one or more reference signals. Then at step 1430 the communications device identifies, based on the received first transmission, an uplink pathloss for the communications device on the first air interface. The method then continues to step 1440 of controlling an uplink power for the communications device, based on the uplink pathloss.

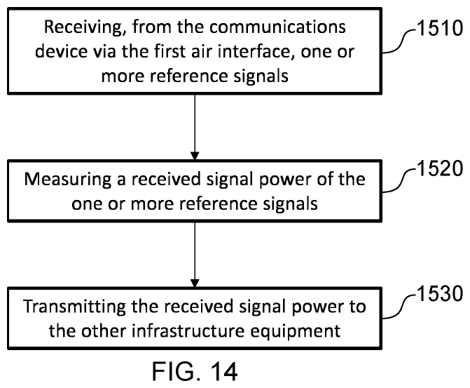

FIG. 14 illustrates a method for an infrastructure equipment in accordance with an example embodiment. The infrastructure equipment is configured to receive uplink signals from a communication device via a first air interface provided by the infrastructure equipment, wherein the first air interface is an uplink-only interface for the communications device, wherein the infrastructure equipment is further configured to communicate with another infrastructure equipment, wherein the other infrastructure equipment is configured to communicate with the communications device via a second air interface provided by the other infrastructure equipment, wherein the second air interface includes a downlink interface for the communications device.

The method includes step 1510 of receiving, from the communications device via the first air interface, one or more reference signals. The method then proceeds to step 1520 of measuring a received signal power of the one or more reference signals and step 1530 of transmitting the received signal power to the other infrastructure equipment.

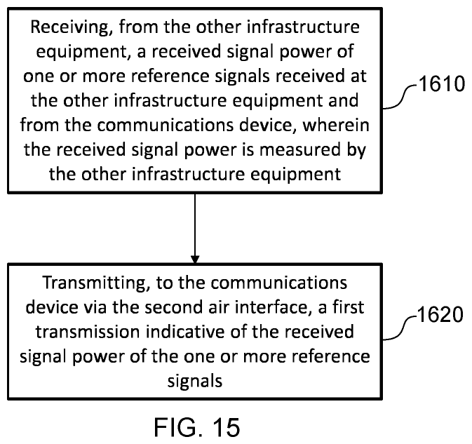

FIG. 15 illustrates a method for an infrastructure equipment in accordance with an example embodiment. The infrastructure equipment is configured to communicate with another infrastructure equipment, wherein the other infrastructure equipment is configured to communicate with the communications device via a first air interface provided by the other infrastructure equipment, wherein the first air interface is an uplink-only interface for the communications device, and wherein the infrastructure equipment is configured to transmit downlink signals to the communications device via a second air interface provided by the infrastructure equipment, wherein the second air interface includes a downlink interface for the communications device.

The method includes step 1610 of receiving, from the other infrastructure equipment, a received signal power of one or more reference signals received at the other infrastructure equipment and from the communications device, wherein the received signal power is measured by the other infrastructure equipment. The method then proceeds to step 1620 of transmitting, to the communications device via the second air interface, a first transmission indicative of the received signal power of the one or more reference signals.

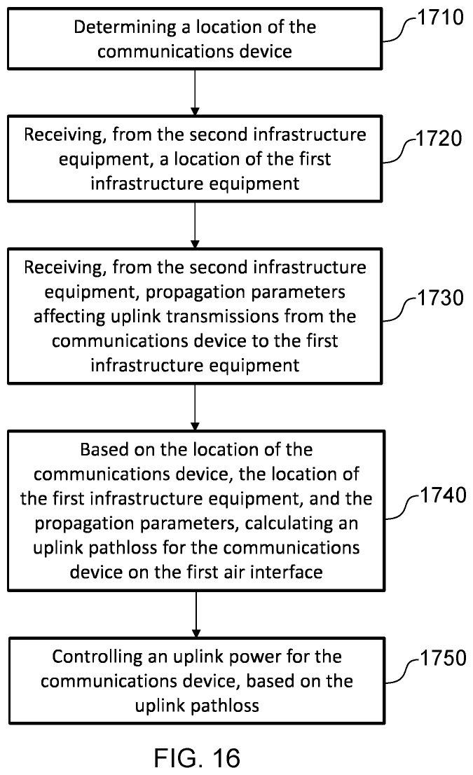

FIG. 16 illustrates a method for a communications device in accordance with an example embodiment. The communications device is configured to communicate with a first infrastructure equipment via a first air interface provided by the first infrastructure equipment, and to communicate with a second infrastructure equipment via a second air interface provided by the second infrastructure equipment, wherein the first air interface is an uplink-only interface for the communications device, and wherein the second air interface includes a downlink interface for the communications device.

The method includes step 1710 of determining a location of the communications device, and step 1720 of receiving, from the second infrastructure equipment, a location of the first infrastructure equipment. The method proceeds to step 1730 of receiving, from the second infrastructure equipment, propagation parameters affecting uplink transmissions from the communications device to the first infrastructure equipment. The method additionally includes step 1740 of, based on the location of the communications device, the location of the first infrastructure equipment, and the propagation parameters, calculating an uplink pathloss for the communications device on the first air interface. Then, the method proceeds to step 1750 of controlling an uplink power for the communications device, based on the uplink pathloss.

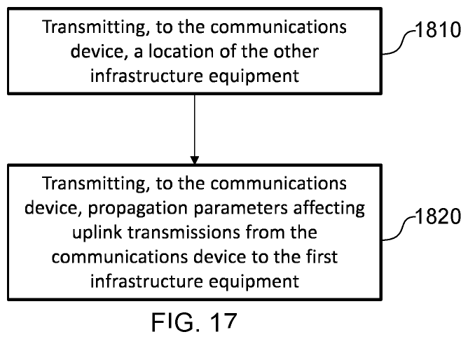

FIG. 17 illustrates a method for an infrastructure equipment in accordance with an example embodiment. The infrastructure equipment is configured to communicate with another infrastructure equipment, wherein the other infrastructure equipment is configured to communicate with the communications device via a first air interface provided by the other infrastructure equipment, wherein the first air interface is an uplink-only interface for the communications device, and wherein the infrastructure equipment is configured to transmit downlink signals to the communications device via a second air interface provided by the infrastructure equipment, wherein the second air interface includes a downlink interface for the communications device.

The method includes step 1810 of transmitting, to the communications device, a location of the other infrastructure equipment. The method then proceeds to step 1820 of transmitting, to the communications device, propagation parameters affecting uplink transmissions from the communications device to the first infrastructure equipment.

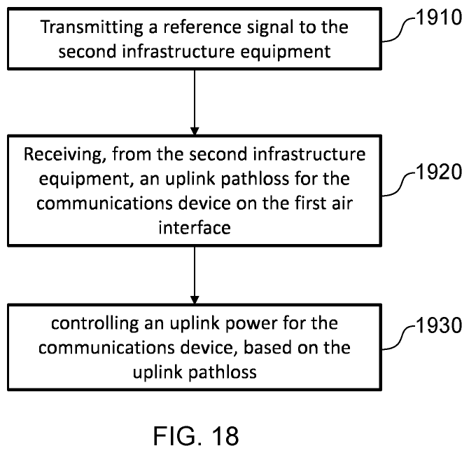

FIG. 18 illustrates a method for a communications device in accordance with an example embodiment. The communications device is configured to communicate with a first infrastructure equipment via a first air interface provided by the first infrastructure equipment, and to communicate with a second infrastructure equipment via a second air interface provided by the second infrastructure equipment, wherein the first air interface is an uplink-only interface for the communications device, and wherein the second air interface includes a downlink interface for the communications device.

The method includes step 1910 of transmitting a reference signal to the second infrastructure equipment. The method then proceeds to step 1920 of receiving, from the second infrastructure equipment, an uplink pathloss for the communications device on the first air interface. The method additionally includes step 1930 of controlling an uplink power for the communications device, based on the uplink pathloss.

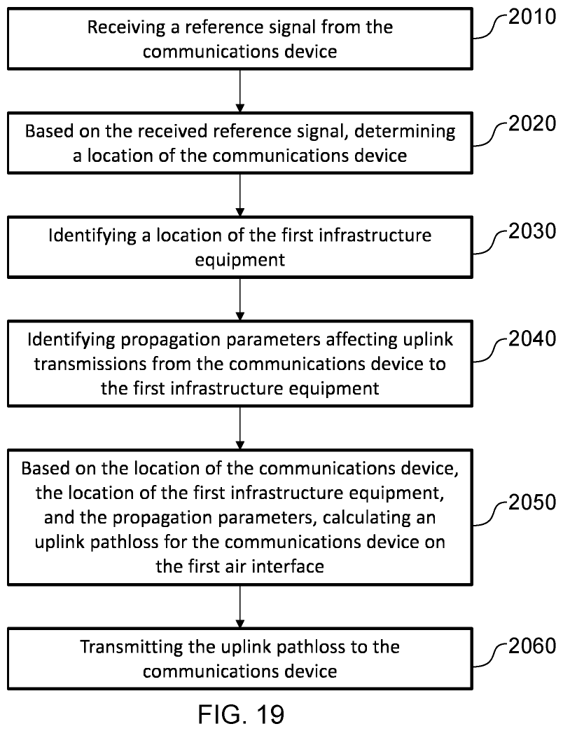

FIG. 19 illustrates a method for an infrastructure equipment in accordance with an example embodiment. The infrastructure equipment is configured to communicate with another infrastructure equipment, wherein the other infrastructure equipment is configured to communicate with the communications device via a first air interface provided by the other infrastructure equipment, wherein the first air interface is an uplink-only interface for the communications device, and wherein the infrastructure equipment is configured to transmit downlink signals to the communications device via a second air interface provided by the infrastructure equipment, wherein the second air interface includes a downlink interface for the communications device.

The method includes step 2010 of receiving a reference signal from the communications device and step 2020 of, based on the received reference signal, determining a location of the communications device. The method then proceeds to step 2030 of identifying a location of the first infrastructure equipment and step 2040 of identifying propagation parameters affecting uplink transmissions from the communications device to the first infrastructure equipment. The method additionally includes step 2050 of, based on the location of the communications device, the location of the first infrastructure equipment, and the propagation parameters, calculating an uplink pathloss for the communications device on the first air interface. The method further includes step 2060 of transmitting the uplink pathloss to the communications device.

The following numbered clauses provide further example aspects and features of the present technique:

1. A system for determining an uplink pathloss for a communications device, the system comprising:
a first infrastructure equipment;
a second infrastructure equipment; and
a communications device configured to communicate with the first infrastructure equipment via a first air interface provided by the first infrastructure equipment, and to communicate with the second infrastructure equipment via a second air interface provided by the second infrastructure equipment,
wherein the first air interface is an uplink-only interface for the communications device, and wherein the second air interface includes a downlink interface for the communications device;
wherein the first infrastructure equipment is configured to:
   receive, from the communications device via the first air interface, one or more reference signals;
   measure a received signal power of the one or more reference signals; and
   transmit the received signal power to the second infrastructure equipment;
wherein the second infrastructure equipment is configured to:
   transmit, to the communications device via the second air interface, a first transmission indicative of the received signal power of the one or more reference signals; and
wherein the communications device is configured to:
   identify, based on the first transmission, an uplink pathloss for the communications device on the first air interface; and
   control an uplink power for the communications device, based on the uplink pathloss.

2. The system of clause 1:
wherein the communications device is configured to:
   determine a transmission power of the one or more reference signals; and
   transmit, to the second infrastructure equipment, information indicative of the transmission power of the one or more reference signals;
wherein the second infrastructure equipment is configured to:
   identify, based on the information indicative of the transmission power of the one or more reference signals, the transmission power of the one or more reference signals; and
   calculate, based on the transmission power and the received signal power of the one or more reference signals, the uplink pathloss; and
wherein transmitting the first transmission indicative of the received signal power of the one or more reference signals includes transmitting the uplink pathloss.

3. The system of clause 2, wherein the communications device is configured to transmit the information indicative of the transmission power of the one or more reference signals as part of the one or more reference signals.

4. The system of clause 3,
wherein the information indicative of the transmission power of the one or more reference signals includes a cyclic shift of the one or more reference signals;
wherein the second infrastructure equipment is configured to identify the transmission power of the one or more reference signals based on the cyclic shift of the one or more reference signals.

5. The system of clause 1:
wherein transmitting the first transmission indicative of the received signal power of the one or more reference signals includes transmitting the received signal power of the one or more reference signals;
wherein the communications device is configured to:
   determine a transmission power of the one or more reference signals; and
   calculate, based on the transmission power and the received signal power of the one or more reference signals, the uplink pathloss.

6. The system of clause 2 or clause 5, wherein the information indicative of the transmission power of the one or more reference signals includes the transmission power of the one or more reference signals.

7. The system of clause 6,
wherein the one or more reference signals include a plurality of reference signals transmitted at a constant transmission power; and
wherein the first infrastructure equipment is configured to measure a received signal power of the plurality of reference signals over a first time period, and calculate an average of the received signal power of the plurality of reference signals as the received signal power.

8. The system of clause 6 or clause 7, wherein the transmission power of the one or more reference signals is a predetermined transmission power, and wherein the second infrastructure equipment is configured to broadcast an instruction for the communications device to transmit the one or more reference signals at the predetermined transmission power.

9. The system of clause any of clauses 2-8,
wherein determining a transmission power of the one or more reference signals includes the communications device performing a power headroom measurement; and
wherein the transmission power of the one or more reference signals are transmitted to the second infrastructure equipment in a power headroom report, the power headroom report including a result of the power headroom measurement.

10. The system of any preceding clause, wherein the second infrastructure equipment is configured to transmit, to the communications device, configuration information for the one or more reference signals.

11. The system according to clause 10, wherein the configuration information for the one or more reference signals is distinct from the one or more other reference signals for a beam management process.

12. The system according to clause 10, or clause 11, wherein configuration information for the one or more reference signals instructs the communications device not to apply power control to the one or more reference signals.

13. The system of any preceding clause,
wherein the one or more reference signals include a plurality of reference signals; and
wherein the first infrastructure equipment is configured to measure a received signal power of the plurality of reference signals over a first time period, and calculate an average of the received signal power of the plurality of reference signals as the received signal power.

14. The system of any preceding clause, wherein the second infrastructure equipment is configured to:
transmit, to the communications device, an activation message, wherein the activation message indicates the commencement of a measurement period in which the communications device is to transmit the one or more reference signals; and
transmit, to the communications device, a deactivation message, wherein the deactivation message indicates the conclusion of the measurement period in which the communications device is to transmit the one or more reference signals.

15. The system of any preceding clause, wherein the second infrastructure equipment is configured to:
transmit, to the communications device, an activation message, wherein the activation message indicates the commencement of a measurement period in which the communications device is to transmit the one or more reference signals, and a timer value indicating the conclusion of the measurement period.

16. The system of any preceding clause, wherein the second air interface further includes an uplink interface for the communications device.

17. The system of any of clauses 1-15, wherein the second air interface is a downlink-only interface for the communications device.

18. The system of any preceding clause, wherein the second infrastructure equipment is configured to provide a further air interface, wherein the further air interface includes an uplink interface for one or more further communications devices.

19. The system of any preceding clause, wherein the first infrastructure equipment is configured to provide a third air interface, wherein the third air interface includes a downlink interface for one or more further communications devices.

20. A communications device comprising:
a controller; and
a transceiver configured to transmit uplink signals and/or receive downlink signals;
wherein the controller is configured with the transceiver to communicate with a first infrastructure equipment via a first air interface provided by the first infrastructure equipment, and to communicate with a second infrastructure equipment via a second air interface provided by the second infrastructure equipment;
wherein the first air interface is an uplink-only interface for the communications device, and wherein the second air interface includes a downlink interface for the communications device; and
wherein the communications device is configured to:
   transmit, to the first infrastructure equipment via the first air interface, one or more reference signals;
   receive, from the second infrastructure equipment, a first transmission indicative of the received signal power of the one or more reference signals;
   identify, based on the received first transmission, an uplink pathloss for the communications device on the first air interface; and
   control an uplink power for the communications device, based on the uplink pathloss.

21. A method of operating a communications device configured to communicate with a first infrastructure equipment via a first air interface provided by the first infrastructure equipment, and to communicate with a second infrastructure equipment via a second air interface provided by the second infrastructure equipment, wherein the first air interface is an uplink-only interface for the communications device, and wherein the second air interface includes a downlink interface for the communications device;
wherein the method comprises:
   transmitting, to the first infrastructure equipment via the first air interface, one or more reference signals;
   receiving, from the second infrastructure equipment, a first transmission indicative of the received signal power of the one or more reference signals;
   identifying, based on the received first transmission, an uplink pathloss for the communications device on the first air interface; and
   controlling an uplink power for the communications device, based on the uplink pathloss.

22. Circuitry for a communications device, the circuitry comprising:
controller circuitry; and
transceiver circuitry, configured to transmit uplink signals and/or receive downlink signals;
wherein the controller circuitry is configured with the transceiver circuitry to communicate with a first infrastructure equipment via a first air interface provided by the first infrastructure equipment, and to communicate with a second infrastructure equipment via a second air interface provided by the second infrastructure equipment; wherein the first air interface is an uplink-only interface for the communications device, and wherein the second air interface includes a downlink interface for the communications device; and
wherein the controller circuitry is configured with the transceiver circuitry to:
   transmit, to the first infrastructure equipment via the first air interface, one or more reference signals;
   receive, from the second infrastructure equipment, a first transmission indicative of the received signal power of the one or more reference signals;
   identify, based on the received first transmission, an uplink pathloss for the communications device on the first air interface; and
   control an uplink power for the communications device, based on the uplink pathloss.

23. An infrastructure equipment comprising:
a controller;
a transceiver configured to receive uplink signals from a communication device via a first air interface provided by the infrastructure equipment, wherein the first air interface is an uplink-only interface for the communications device; and
a network interface configured to transmit signals to and/or receive signals from another infrastructure equipment, wherein the other infrastructure equipment is configured to communicate with the communications device via a second air interface provided by the other infrastructure equipment, wherein the second air interface includes a downlink interface for the communications device; and
wherein the controller together with the transceiver and network interface is configured to cause the infrastructure equipment to:
   receive, from the communications device via the first air interface, one or more reference signals;
   measure a received signal power of the one or more reference signals; and
   transmit the received signal power to the other infrastructure equipment.

24. A method of operating an infrastructure equipment configured to receive uplink signals from a communication device via a first air interface provided by the infrastructure equipment, wherein the first air interface is an uplink-only interface for the communications device, wherein the infrastructure equipment is further configured to communicate with another infrastructure equipment, wherein the other infrastructure equipment is configured to communicate with the communications device via a second air interface provided by the other infrastructure equipment, wherein the second air interface includes a downlink interface for the communications device;
wherein the method comprises:
   receiving, from the communications device via the first air interface, one or more reference signals;
   measuring a received signal power of the one or more reference signals; and
   transmitting the received signal power to the other infrastructure equipment.

25. Circuitry for an infrastructure equipment, the circuitry comprising:
controller circuitry;
transceiver circuitry configured to receive uplink signals from a communication device via a first air interface provided by the infrastructure equipment, wherein the first air interface is an uplink-only interface for the communications device; and
network interface circuitry configured to transmit signals to and/or receive signals from another infrastructure equipment, wherein the other infrastructure equipment is configured to communicate with the communications device via a second air interface provided by the other infrastructure equipment, wherein the second air interface includes a downlink interface for the communications device;
wherein the controller circuitry together with the transceiver circuitry and network interface circuitry is configured to cause the infrastructure equipment to:
   receive, from the communications device via the first air interface, one or more reference signals;
   measure a received signal power of the one or more reference signals; and
   transmit the received signal power to the other infrastructure equipment.

26. An infrastructure equipment comprising:
a controller;
a transceiver configured to transmit downlink signals to a communications device; and
a network interface configured to transmit signals to and/or receive signals from another infrastructure equipment, wherein the other infrastructure equipment is configured to communicate with the communications device via a first air interface provided by the other infrastructure equipment, wherein the first air interface is an uplink-only interface for the communications device, and wherein the infrastructure equipment is configured to transmit downlink signals to the communications device via a second air interface provided by the infrastructure equipment, wherein the second air interface includes a downlink interface for the communications device;
wherein the controller together with the transceiver and network interface is configured to cause the infrastructure equipment to:
   receive, from the other infrastructure equipment, a received signal power of one or more reference signals received at the other infrastructure equipment and from the communications device, wherein the received signal power is measured by the other infrastructure equipment; and
   transmit, to the communications device via the second air interface, a first transmission indicative of the received signal power of the one or more reference signals.

27. A method of operating an infrastructure equipment configured to communicate with another infrastructure equipment, wherein the other infrastructure equipment is configured to communicate with the communications device via a first air interface provided by the other infrastructure equipment, wherein the first air interface is an uplink-only interface for the communications device, and wherein the infrastructure equipment is configured to transmit downlink signals to the communications device via a second air interface provided by the infrastructure equipment, wherein the second air interface includes a downlink interface for the communications device;
wherein the method comprises:
   receiving, from the other infrastructure equipment, a received signal power of one or more reference signals received at the other infrastructure equipment and from the communications device, wherein the received signal power is measured by the other infrastructure equipment; and
   transmitting, to the communications device via the second air interface, a first transmission indicative of the received signal power of the one or more reference signals.

28. Circuitry for an infrastructure equipment, the circuitry comprising:
controller circuitry;
transceiver circuitry configured to transmit downlink signals to a communications device; and
network interface circuitry configured to transmit signals to and/or receive signals from another infrastructure equipment, wherein the other infrastructure equipment is configured to communicate with the communications device via a first air interface provided by the other infrastructure equipment, wherein the first air interface is an uplink-only interface for the communications device, and wherein the infrastructure equipment is configured to transmit downlink signals to the communications device via a second air interface provided by the infrastructure equipment, wherein the second air interface includes a downlink interface for the communications device;
wherein the controller circuitry together with the transceiver circuitry and network interface circuitry is configured to cause the infrastructure equipment to:
   receive, from the other infrastructure equipment, a received signal power of one or more reference signals received at the other infrastructure equipment and from the communications device, wherein the received signal power is measured by the other infrastructure equipment; and
   transmit, to the communications device via the second air interface, a first transmission indicative of the received signal power of the one or more reference signals.

29. A system for determining an uplink pathloss for a communications device, the system comprising:
a communications device, a first infrastructure equipment, and a second infrastructure equipment, wherein the communications device configured to communicate with the first infrastructure equipment via a first air interface provided by the first infrastructure equipment, and to communicate with the second infrastructure equipment via a second air interface provided by the second infrastructure equipment, wherein the first air interface is an uplink-only interface for the communications device, and wherein the second air interface includes a downlink interface for the communications device;
wherein the communications device is configured to:
   determine a location of the communications device;
   receive, from the second infrastructure equipment, a location of the first infrastructure equipment,
   receive, from the second infrastructure equipment, propagation parameters affecting uplink transmissions from the communications device to the first infrastructure equipment;
   based on the location of the communications device, the location of the first infrastructure equipment, and the propagation parameters, calculate an uplink pathloss for the communications device on the first air interface; and
   control an uplink power for the communications device, based on the uplink pathloss.

30. A communications device comprising:
a controller; and
a transceiver configured to transmit uplink signals and/or receive downlink signals;
wherein the controller is configured with the transceiver to communicate with a first infrastructure equipment via a first air interface provided by the first infrastructure equipment, and to communicate with a second infrastructure equipment via a second air interface provided by the second infrastructure equipment;
wherein the first air interface is an uplink-only interface for the communications device, and wherein the second air interface includes a downlink interface for the communications device; and
wherein the communications device is configured to:
   determine a location of the communications device;
   receive, from the second infrastructure equipment, a location of the first infrastructure equipment,
   receive, from the second infrastructure equipment, propagation parameters affecting uplink transmissions from the communications device to the first infrastructure equipment;
   based on the location of the communications device, the location of the first infrastructure equipment, and the propagation parameters, calculate an uplink pathloss for the communications device on the first air interface; and
   control an uplink power for the communications device, based on the uplink pathloss.

31. A method of operating a communications device configured to communicate with a first infrastructure equipment via a first air interface provided by the first infrastructure equipment, and to communicate with a second infrastructure equipment via a second air interface provided by the second infrastructure equipment, wherein the first air interface is an uplink-only interface for the communications device, and wherein the second air interface includes a downlink interface for the communications device;
wherein the method comprises:
   determining a location of the communications device;
   receiving, from the second infrastructure equipment, a location of the first infrastructure equipment,
   receiving, from the second infrastructure equipment, propagation parameters affecting uplink transmissions from the communications device to the first infrastructure equipment;
   based on the location of the communications device, the location of the first infrastructure equipment, and the propagation parameters, calculating an uplink pathloss for the communications device on the first air interface; and
   controlling an uplink power for the communications device, based on the uplink pathloss.

32. Circuitry for a communications device, the circuitry comprising:
controller circuitry; and
transceiver circuitry, configured to transmit uplink signals and/or receive downlink signals;
wherein the controller circuitry is configured with the transceiver circuitry to communicate with a first infrastructure equipment via a first air interface provided by the first infrastructure equipment, and to communicate with a second infrastructure equipment via a second air interface provided by the second infrastructure equipment; wherein the first air interface is an uplink-only interface for the communications device, and wherein the second air interface includes a downlink interface for the communications device; and
wherein the controller circuitry is configured with the transceiver circuitry to:
   determine a location of the communications device;
   receive, from the second infrastructure equipment, a location of the first infrastructure equipment,
   receive, from the second infrastructure equipment, propagation parameters affecting uplink transmissions from the communications device to the first infrastructure equipment;
   based on the location of the communications device, the location of the first infrastructure equipment, and the propagation parameters, calculate an uplink pathloss for the communications device on the first air interface; and
   control an uplink power for the communications device, based on the uplink pathloss.

33. An infrastructure equipment comprising:
a controller;
a transceiver configured to transmit downlink signals to a communications device; and
a network interface configured to transmit signals to and/or receive signals from another infrastructure equipment, wherein the other infrastructure equipment is configured to communicate with the communications device via a first air interface provided by the other infrastructure equipment, wherein the first air interface is an uplink-only interface for the communications device, and wherein the infrastructure equipment is configured to transmit downlink signals to the communications device via a second air interface provided by the infrastructure equipment, wherein the second air interface includes a downlink interface for the communications device;
wherein the controller together with the transceiver and network interface is configured to cause the infrastructure equipment to:
   transmit, to the communications device, a location of the other infrastructure equipment,
   transmit, to the communications device, propagation parameters affecting uplink transmissions from the communications device to the first infrastructure equipment.

34. A method of operating an infrastructure equipment configured to communicate with another infrastructure equipment, wherein the other infrastructure equipment is configured to communicate with the communications device via a first air interface provided by the other infrastructure equipment, wherein the first air interface is an uplink-only interface for the communications device, and wherein the infrastructure equipment is configured to transmit downlink signals to the communications device via a second air interface provided by the infrastructure equipment, wherein the second air interface includes a downlink interface for the communications device;
wherein the method comprises:
   transmitting, to the communications device, a location of the other infrastructure equipment,
   transmitting, to the communications device, propagation parameters affecting uplink transmissions from the communications device to the first infrastructure equipment.

35. Circuitry for an infrastructure equipment, the circuitry comprising:
controller circuitry;
transceiver circuitry configured to transmit downlink signals to a communications device; and
network interface circuitry configured to transmit signals to and/or receive signals from another infrastructure equipment, wherein the other infrastructure equipment is configured to communicate with the communications device via a first air interface provided by the other infrastructure equipment, wherein the first air interface is an uplink-only interface for the communications device, and wherein the infrastructure equipment is configured to transmit downlink signals to the communications device via a second air interface provided by the infrastructure equipment, wherein the second air interface includes a downlink interface for the communications device;
wherein the controller circuitry together with the transceiver circuitry and network interface circuitry is configured to cause the infrastructure equipment to:
   transmit, to the communications device, a location of the other infrastructure equipment,
   transmit, to the communications device, propagation parameters affecting uplink transmissions from the communications device to the first infrastructure equipment.

36. A system for determining an uplink pathloss for a communications device, the system comprising:
a communications device, a first infrastructure equipment, and a second infrastructure equipment, wherein the communications device configured to communicate with the first infrastructure equipment via a first air interface provided by the first infrastructure equipment, and to communicate with the second infrastructure equipment via a second air interface provided by the second infrastructure equipment, wherein the first air interface is an uplink-only interface for the communications device, and wherein the second air interface includes a downlink interface for the communications device;
wherein the second infrastructure equipment is configured to:
   receive a reference signal from the communications device;
   based on the received reference signal, determine a location of the communications device;
   identify a location of the first infrastructure equipment;
   identify propagation parameters affecting uplink transmissions from the communications device to the first infrastructure equipment;
   based on the location of the communications device, the location of the first infrastructure equipment, and the propagation parameters, calculate an uplink pathloss for the communications device on the first air interface;
   transmit the uplink pathloss to the communications device.

37. The system of clause 36, wherein determining the location of the communications device comprises:
measuring timing information for the reference signal;
transmitting the measured timing information to a location server;
receiving, from the location server, the location of the communications device.

38. The system of clause 37, wherein the timing information for the reference signal is an uplink time difference of arrival (U-TDOA).

39. A communications device comprising:
a controller; and
a transceiver configured to transmit uplink signals and/or receive downlink signals;
wherein the controller is configured with the transceiver to communicate with a first infrastructure equipment via a first air interface provided by the first infrastructure equipment, and to communicate with a second infrastructure equipment via a second air interface provided by the second infrastructure equipment;
wherein the first air interface is an uplink-only interface for the communications device, and wherein the second air interface includes a downlink interface for the communications device; and
wherein the communications device is configured to:
   transmit a reference signal to the second infrastructure equipment,
   receive, from the second infrastructure equipment, an uplink pathloss for the communications device on the first air interface, and
   control an uplink power for the communications device, based on the uplink pathloss.

40. A method of operating a communications device configured to communicate with a first infrastructure equipment via a first air interface provided by the first infrastructure equipment, and to communicate with a second infrastructure equipment via a second air interface provided by the second infrastructure equipment, wherein the first air interface is an uplink-only interface for the communications device, and wherein the second air interface includes a downlink interface for the communications device;
wherein the method comprises:
   transmitting a reference signal to the second infrastructure equipment,
   receiving, from the second infrastructure equipment, an uplink pathloss for the communications device on the first air interface, and
   controlling an uplink power for the communications device, based on the uplink pathloss.

41. Circuitry for a communications device, the circuitry comprising:
controller circuitry; and
transceiver circuitry, configured to transmit uplink signals and/or receive downlink signals;
wherein the controller circuitry is configured with the transceiver circuitry to communicate with a first infrastructure equipment via a first air interface provided by the first infrastructure equipment, and to communicate with a second infrastructure equipment via a second air interface provided by the second infrastructure equipment; wherein the first air interface is an uplink-only interface for the communications device, and wherein the second air interface includes a downlink interface for the communications device; and
wherein the controller circuitry is configured with the transceiver circuitry to:
   transmit a reference signal to the second infrastructure equipment,
   receive, from the second infrastructure equipment, an uplink pathloss for the communications device on the first air interface, and
   control an uplink power for the communications device, based on the uplink pathloss.

42. An infrastructure equipment comprising:
a controller;
a transceiver configured to transmit downlink signals to a communications device; and
a network interface configured to transmit signals to and/or receive signals from another infrastructure equipment, wherein the other infrastructure equipment is configured to communicate with the communications device via a first air interface provided by the other infrastructure equipment, wherein the first air interface is an uplink-only interface for the communications device, and wherein the infrastructure equipment is configured to transmit downlink signals to the communications device via a second air interface provided by the infrastructure equipment, wherein the second air interface includes a downlink interface for the communications device;
wherein the controller together with the transceiver and network interface is configured to cause the infrastructure equipment to:
   receive a reference signal from the communications device;
   based on the received reference signal, determine a location of the communications device;
   identify a location of the first infrastructure equipment;
   identify propagation parameters affecting uplink transmissions from the communications device to the first infrastructure equipment;
   based on the location of the communications device, the location of the first infrastructure equipment, and the propagation parameters, calculate an uplink pathloss for the communications device on the first air interface;
   transmit the uplink pathloss to the communications device.

43. A method of operating an infrastructure equipment configured to communicate with another infrastructure equipment, wherein the other infrastructure equipment is configured to communicate with the communications device via a first air interface provided by the other infrastructure equipment, wherein the first air interface is an uplink-only interface for the communications device, and wherein the infrastructure equipment is configured to transmit downlink signals to the communications device via a second air interface provided by the infrastructure equipment, wherein the second air interface includes a downlink interface for the communications device;
wherein the method comprises:
   receiving a reference signal from the communications device;
   based on the received reference signal, determining a location of the communications device;
   identifying a location of the first infrastructure equipment;
   identifying propagation parameters affecting uplink transmissions from the communications device to the first infrastructure equipment;
   based on the location of the communications device, the location of the first infrastructure equipment, and the propagation parameters, calculating an uplink pathloss for the communications device on the first air interface;
   transmitting the uplink pathloss to the communications device.

44. Circuitry for an infrastructure equipment, the circuitry comprising:
controller circuitry;
transceiver circuitry configured to transmit downlink signals to a communications device; and
network interface circuitry configured to transmit signals to and/or receive signals from another infrastructure equipment, wherein the other infrastructure equipment is configured to communicate with the communications device via a first air interface provided by the other infrastructure equipment, wherein the first air interface is an uplink-only interface for the communications device, and wherein the infrastructure equipment is configured to transmit downlink signals to the communications device via a second air interface provided by the infrastructure equipment, wherein the second air interface includes a downlink interface for the communications device;
wherein the controller circuitry together with the transceiver circuitry and network interface circuitry is configured to cause the infrastructure equipment to:
   receive a reference signal from the communications device;
   based on the received reference signal, determine a location of the communications device;
   identify a location of the first infrastructure equipment;
   identify propagation parameters affecting uplink transmissions from the communications device to the first infrastructure equipment;
   based on the location of the communications device, the location of the first infrastructure equipment, and the propagation parameters, calculate an uplink pathloss for the communications device on the first air interface;
   transmit the uplink pathloss to the communications device.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] RP-212702 New WID on NR UL Enhancements
[3] 3GPP TS 38.101-1, “NR; User Equipment (UE) radio transmission and reception; Part 1: Range 1 Standalone”.

1.-19. (canceled)

20. A communications device comprising:
a controller; and
a transceiver configured to transmit uplink signals and/or receive downlink signals;
wherein the controller is configured with the transceiver to communicate with a first infrastructure equipment via a first air interface provided by the first infrastructure equipment, and to communicate with a second infrastructure equipment via a second air interface provided by the second infrastructure equipment;
wherein the first air interface is an uplink-only interface for the communications device, and wherein the second air interface includes a downlink interface for the communications device; and
wherein the communications device is configured to:
transmit, to the first infrastructure equipment via the first air interface, one or more reference signals;
receive, from the second infrastructure equipment, a first transmission indicative of an uplink pathloss the one or more reference signals;
identify, based on the received first transmission, the uplink pathloss for the communications device on the first air interface; and
control an uplink power for the communications device, based on the uplink pathloss.

21.-44. (canceled)

45. The communications device of claim 20:
wherein the communications device is configured to:
determine a transmission power of the one or more reference signals; and
transmit, to the second infrastructure equipment, information indicative of the transmission power of the one or more reference signals;
wherein the second infrastructure equipment is configured to:
identify, based on the information indicative of the transmission power of the one or more reference signals, the transmission power of the one or more reference signals; and
calculate, based on the transmission power and the received signal power of the one or more reference signals, the uplink pathloss; and
wherein transmitting the first transmission indicative of the received signal power of the one or more reference signals includes transmitting the uplink pathloss.

46. The communications device of claim 45, wherein the communications device is configured to transmit the information indicative of the transmission power of the one or more reference signals as part of the one or more reference signals.

47. The communications device of claim 46,
wherein the information indicative of the transmission power of the one or more reference signals includes a cyclic shift of the one or more reference signals;
wherein the second infrastructure equipment is configured to identify the transmission power of the one or more reference signals based on the cyclic shift of the one or more reference signals.

48. The communications device of claim 47:
wherein transmitting the first transmission indicative of the received signal power of the one or more reference signals includes transmitting the received signal power of the one or more reference signals;
wherein the communications device is configured to:
determine a transmission power of the one or more reference signals; and
calculate, based on the transmission power and the received signal power of the one or more reference signals, the uplink pathloss.

49. The communications device of claim 48, wherein the information indicative of the transmission power of the one or more reference signals includes the transmission power of the one or more reference signals.

50. The communications device of claim 49,
wherein the one or more reference signals include a plurality of reference signals transmitted at a constant transmission power; and
wherein the first infrastructure equipment is configured to measure a received signal power of the plurality of reference signals over a first time period, and calculate an average of the received signal power of the plurality of reference signals as the received signal power.

51. The communications device of claim 50, wherein the transmission power of the one or more reference signals is a predetermined transmission power, and wherein the second infrastructure equipment is configured to broadcast an instruction for the communications device to transmit the one or more reference signals at the predetermined transmission power.

52. The communications device of claim 45,
wherein determining a transmission power of the one or more reference signals includes the communications device performing a power headroom measurement; and
wherein the transmission power of the one or more reference signals are transmitted to the second infrastructure equipment in a power headroom report, the power headroom report including a result of the power headroom measurement.

53. The communications device of claim 20, wherein the second infrastructure equipment is configured to transmit, to the communications device, configuration information for the one or more reference signals.

54. The communications device according to claim 53, wherein the configuration information for the one or more reference signals is distinct from the one or more other reference signals for a beam management process.

55. The communications device according to claim 53, wherein configuration information for the one or more reference signals instructs the communications device not to apply power control to the one or more reference signals.

56. The communications device of claim 20,
wherein the one or more reference signals include a plurality of reference signals; and
wherein the first infrastructure equipment is configured to measure a received signal power of the plurality of reference signals over a first time period, and calculate an average of the received signal power of the plurality of reference signals as the received signal power.

57. The communications device of claim 20, wherein the second infrastructure equipment is configured to:
transmit, to the communications device, an activation message, wherein the activation message indicates the commencement of a measurement period in which the communications device is to transmit the one or more reference signals; and
transmit, to the communications device, a deactivation message, wherein the deactivation message indicates the conclusion of the measurement period in which the communications device is to transmit the one or more reference signals.

58. The communications device of claim 20, wherein the second infrastructure equipment is configured to:
transmit, to the communications device, an activation message, wherein the activation message indicates the commencement of a measurement period in which the communications device is to transmit the one or more reference signals, and a timer value indicating the conclusion of the measurement period.

59. The communications device of claim 20, wherein the second air interface further includes an uplink interface for the communications device.

60. A method of operating a communications device configured to communicate with a first infrastructure equipment via a first air interface provided by the first infrastructure equipment, and to communicate with a second infrastructure equipment via a second air interface provided by the second infrastructure equipment, wherein the first air interface is an uplink-only interface for the communications device, and wherein the second air interface includes a downlink interface for the communications device;
wherein the method comprises:
transmitting, to the first infrastructure equipment via the first air interface, one or more reference signals;
receiving, from the second infrastructure equipment, a first transmission indicative of an uplink pathloss of the one or more reference signals;
identifying, based on the received first transmission, the uplink pathloss for the communications device on the first air interface; and
controlling an uplink power for the communications device, based on the uplink pathloss.

61. Circuitry for a communications device, the circuitry comprising:
controller circuitry; and
transceiver circuitry, configured to transmit uplink signals and/or receive downlink signals;
wherein the controller circuitry is configured with the transceiver circuitry to communicate with a first infrastructure equipment via a first air interface provided by the first infrastructure equipment, and to communicate with a second infrastructure equipment via a second air interface provided by the second infrastructure equipment; wherein the first air interface is an uplink-only interface for the communications device, and wherein the second air interface includes a downlink interface for the communications device; and
wherein the controller circuitry is configured with the transceiver circuitry to:
transmit, to the first infrastructure equipment via the first air interface, one or more reference signals;
receive, from the second infrastructure equipment, a first transmission indicative of an uplink pathloss of the one or more reference signals;
identify, based on the received first transmission, the uplink pathloss for the communications device on the first air interface; and
control an uplink power for the communications device, based on the uplink pathloss.

62. An infrastructure equipment comprising:
a controller;
a transceiver configured to transmit downlink signals to a communications device; and
a network interface configured to transmit signals to and/or receive signals from another infrastructure equipment, wherein the other infrastructure equipment is configured to communicate with the communications device via a first air interface provided by the other infrastructure equipment, wherein the first air interface is an uplink-only interface for the communications device, and wherein the infrastructure equipment is configured to transmit downlink signals to the communications device via a second air interface provided by the infrastructure equipment, wherein the second air interface includes a downlink interface for the communications device;
wherein the controller together with the transceiver and network interface is configured to cause the infrastructure equipment to:
receive, from the other infrastructure equipment, a received signal power of one or more reference signals received at the other infrastructure equipment and from the communications device, wherein the received signal power is measured by the other infrastructure equipment; and
transmit, to the communications device via the second air interface, a first transmission indicative of an uplink pathloss of the one or more reference signals.

63. A method of operating an infrastructure equipment configured to communicate with another infrastructure equipment, wherein the other infrastructure equipment is configured to communicate with the communications device via a first air interface provided by the other infrastructure equipment, wherein the first air interface is an uplink-only interface for the communications device, and wherein the infrastructure equipment is configured to transmit downlink signals to the communications device via a second air interface provided by the infrastructure equipment, wherein the second air interface includes a downlink interface for the communications device;
wherein the method comprises:
receiving, from the other infrastructure equipment, a received signal power of one or more reference signals received at the other infrastructure equipment and from the communications device, wherein the received signal power is measured by the other infrastructure equipment; and
transmitting, to the communications device via the second air interface, a first transmission indicative of an uplink pathloss of the one or more reference signals.
